(19) United States
(12) Patent Application Publication
(10) Pub. No.: US 2013/0332194 A1
(43) Pub. Date: Dec. 12, 2013

(54) METHODS AND SYSTEMS FOR ADAPTIVE EHR DATA INTEGRATION, QUERY, ANALYSIS, REPORTING, AND CROWDSOURCED EHR APPLICATION DEVELOPMENT

(71) Applicant: IQUARTIC, Cambridge, MA (US)

(72) Inventors: Timothy D'Auria, Sharon, MA (US); Ze Jiang, Brookline, MA (US); Qing Ye, Morrisville, NC (US); Daniel A. Griffin, Watertown, MA (US)

(21) Appl. No.: 13/843,767

(22) Filed: Mar. 15, 2013

Related U.S. Application Data
(60) Provisional application No. 61/656,581, filed on Jun. 7, 2012.

(51) Int. Cl. G06F 19/00

(52) U.S. Cl. CPC G06F 19/322
USPC 705/3

(57) ABSTRACT

A method, system, and computer program is provided for interacting with electronic medical health records. The method, system, and computer program may be configured to receive healthcare-related information including financial, patient, and provider related information from at least one electronic source. The healthcare-related information may be electronic health records, and may also be other information such as non-clinical data and environmental monitors. The method, system, and computer program may be further configured to determine a performance indicator of the health-care related information. The method, system, and computer program may be further configured to identify one or more corrective measures based on the performance indicator

### CROSS REFERENCE TO RELATED APPLICATION

This application claims priority to U.S. Provisional Patent Application No. 61/656,581, filed on Jun. 7, 2012, the entire contents of which are hereby incorporated by reference.

### TECHNICAL FIELD

This disclosure is directed towards a computing application, system, and processes for health care management, and, more particularly, towards the same for health care management through access to and analysis of electronic health records such as patient records and financial historical data for any of a patient, service provider, and the like.

### BACKGROUND

Health care records are quickly evolving due to new government regulations requiring electronic health care records and adaptation by hospitals and providers of electronic health records and computing devices. There is much data that can be gleaned from health care records to improve many facets of the health care process, including, for example, improving patient care by universalizing or identifying best practices for a given ailment, and improving hospital efficiency and profitability.

There are a number of drawbacks that these improvements have to coordinate around. For example, electronic health records are not necessarily consistent in format from one electronic health records provider to another. This can make aggregation and analysis of data from multiple providers difficult. Additionally, systems and programs have not been developed that can effectively compile data from electronic health records and then interpret the data into a meaningful output. Accordingly, a need exists for computing applications, systems, and other applications that address these shortcomings.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are one or more methods. For example, one method may include receiving healthcare-related information including financial, patient, and provider related information from at least one electronic source, and determining a performance indicator of the healthcare-related information. At least one electronic source may be EHR systems 162 of data source 160. The performance indicator may be, for example, an indicator of projected revenue losses such as those illustrated in the graphs of FIG. 16A.

The method may include identifying one or more corrective measures based on the performance indicator. A corrective measure may be to determine the reason for non-compliance and addressing that reason with further training, automated processes, or any other effective and appropriate corrective measure.

Receiving healthcare-related information may include receiving information related to quality of care guidelines of a pay for performance healthcare provider contract. Determining a performance indicator may include determining, based on the quality of care guidelines, a compliance rate of a pay for performance contract for a given service provider.

Receiving healthcare-related information may include receiving information related to quality of care guidelines. Determining a performance indicator may include determining, based upon the quality of care guidelines, a compliance rate for a given ailment.

Identifying one or more corrective measures may include communicating the one or more corrective measures to a service provider via electronic message. The electronic message may be an email to a provider, or, alternatively, may be a text or SMS based message for instant notification.

Receiving healthcare-related information may include receiving information related to quality of care guidelines. The one or more methods may include determining that one or more of the quality of care guidelines has not been satisfied. The one or more methods may include determining a financial loss associated with the one or more of the quality of care guidelines that has not been satisfied.

Determining a financial loss may include determining a financial loss and/or predicted financial loss for a given service provider in a healthcare organization. The one or more methods may also include assigning a rank to the financial loss for a given service provider in the healthcare organization.

Identifying one or more corrective measures may include communicating the rank and/or a performance score to the service provider.

Determining a financial loss may include determining a financial loss and/or predicted financial loss for a given department in a healthcare organization. The one or more methods may also include assigning a rank of the financial loss for a given department in the healthcare organization.

Receiving healthcare-related information may include receiving information related to quality of care guidelines. The one or more methods may include determining a performance indicator that includes determining if quality of care guidelines is satisfied for each patient.

Identifying one or more corrective measures may include identifying a patient to which quality of care guidelines have not been satisfied, and the one or more methods may further include communicating to the service provider instructions to satisfy the quality of care guidelines for the patient.

Receiving healthcare-related information may include receiving information related to patient treatment history and medical condition. Determining a performance indicator may include determining, based off the information related to patient treatment history and medical condition, patients that are high-risk. Identifying corrective measures may include sending recommendations to the high-risk patent.

Receiving healthcare-related information may include receiving geographical information related to one of the residence of a patient or the location of a healthcare provider. Determining a performance indicator may include determining a spatial relationship of rendered medical services to a geographic region based on the geographical information related to one of the residence of a patient or the location of the healthcare provider.

The one or more methods may include displaying, on a user interface, data indicative of the spatial relationship.

Receiving healthcare-related information may include receiving healthcare-related information on a computing device.

Receiving healthcare-related information may include receiving financial information of one of a patient, service provider, department, and location. Determining a performance indicator may include determining spending data based on the financial information. The one or more methods may include comparing the spending data of each of the one of the patient, service provider, department, and location.

Receiving healthcare-related information may include receiving healthcare-related information from a plurality of electronic health record providers. The one or more methods may include calculating an empirical similarity between disparate entries of the plurality of electronic health record providers and determining, based on the empirical similarity, whether disparate entries are indicative of the same information from the plurality of electronic health record providers.

Healthcare-related data may include at least one of electronic health records and environmental records. In this manner, any data that may be useful in making an assessment of health or other health related determination may be used.

Environmental records may include one of geography, temperature, air quality, and combinations thereof.

The method may include receiving non healthcare-related records. Ton healthcare-related records may include one of income distribution, and government provided labor and economic data, and combinations thereof.

The one or more methods may include communicating the performance indicator to a requestor.

The one or more methods may include determining if a requestor has permission to receive the performance indicator.

The one or more methods may include displaying, on a user interface, a timeline that contains healthcare-related information for a given patient.

The one or more methods may include comparing metadata from the healthcare-related information in order to determine a performance indicator of the healthcare-related information.

The one or more methods may include determining if any of the healthcare-related information is sensitive information, and in response to determining that information is sensitive, obfuscating said information.

The one or more methods may include receiving programming instructions from a third party.

The one or more methods may include receiving healthcare-related information including financial, patient, and provider related information from a plurality of electronic sources, and comparing values from one of the plurality of electronic sources to values of another of the plurality of electronic sources to determine a likelihood of matching for a given pair of values.

The one or more methods may include comparing values from one of the plurality of electronic sources that may include comparing at least two values from one of the plurality of electronic sources to at least two values from another of the plurality of electronic sources.

The one or more methods may include plotting a frequency histogram for a given value of one of the plurality of electronic sources and plotting a frequency histogram for a given value of another of the plurality of electronic sources.

The one or more methods may include comparing values comprises comparing the frequency histogram for a given value of one of the plurality of electronic sources with a histogram for a given value of another of the plurality of electronic sources.

The one or more methods may include comparing values from one of the plurality of electronic sources comprises using a stochastic analysis.

A system may be provided herein. The system may include a data source having a plurality of electronic sources comprising one of electronic health record, non-clinical data, environmental data, and combinations thereof.

The system may include an analytics module. The analytics module may be configured to receive data from a plurality of electronic sources of the data source, and compare values from one of the plurality of electronic sources to values of another of the plurality of electronic sources to determine a likelihood of matching for a given pair of values.

The system may include an application module. The application module may have at least one application that is downloadable by a user.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 illustrates a system 100 for analyzing health care data according to one or more embodiments illustrated herein;

FIGS. 2A, 2B, 2C, and 2D illustrate graphical representations of a patient population and related healthcare data according to one or more embodiments disclosed herein;

FIGS. 3 and 4 illustrated frequency histograms of EHR data matching according to one or more embodiments disclosed herein;

FIG. 5 illustrates a timeline display for a patient treatment history according to one or more embodiments disclosed herein;

FIG. 6 illustrates a method and process for machine learning of EHR data mapping according to one or more embodiments disclosed herein;

FIG. 7 illustrates a method and process of supervised machine learning for EHR data mapping according to one or more embodiments disclosed herein;

FIG. 8 illustrates a method and process of unsupervised machine learning for HER data mapping according to one or more embodiments disclosed herein;

FIG. 9 illustrates a schematic diagram of an embodiment of the EHR analytics platform according to one or more embodiments disclosed herein;

FIG. 10 illustrates a crowdsourced analytics and EHR application store according to one or more embodiments disclosed herein;

FIG. 11 illustrates a method and process of crowdsourced analysis of HIPAA, HITECH, and other sensitive data according to one or more embodiments disclosed herein;

FIG. 12 illustrates an additional method and process of crowdsources analysis of HIPAA, HITECH, and other sensitive data according to one or more embodiments disclosed herein;

FIG. 13 illustrates a method and process of geospatial analysis of EHR according to one or more embodiments disclosed herein;

FIG. 14 illustrates a method and process of EHR quality to revenue analysis process according to one or more embodiments disclosed herein;

FIG. 15 illustrates a method and process for combining and analyzing EHR data with non-healthcare data;

FIGS. 16A, 16B, 16C, and 16D illustrates one or more graphical displays of analysis data from the one or more systems, methods, and processes according to one or more embodiments disclosed herein;

FIG. 17 illustrates an example of machine learning for EHR data mapping according to one or more embodiments disclosed herein; and

FIG. 18 illustrates a graphical display of a clinician scorecard according to one or more embodiments disclosed herein.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

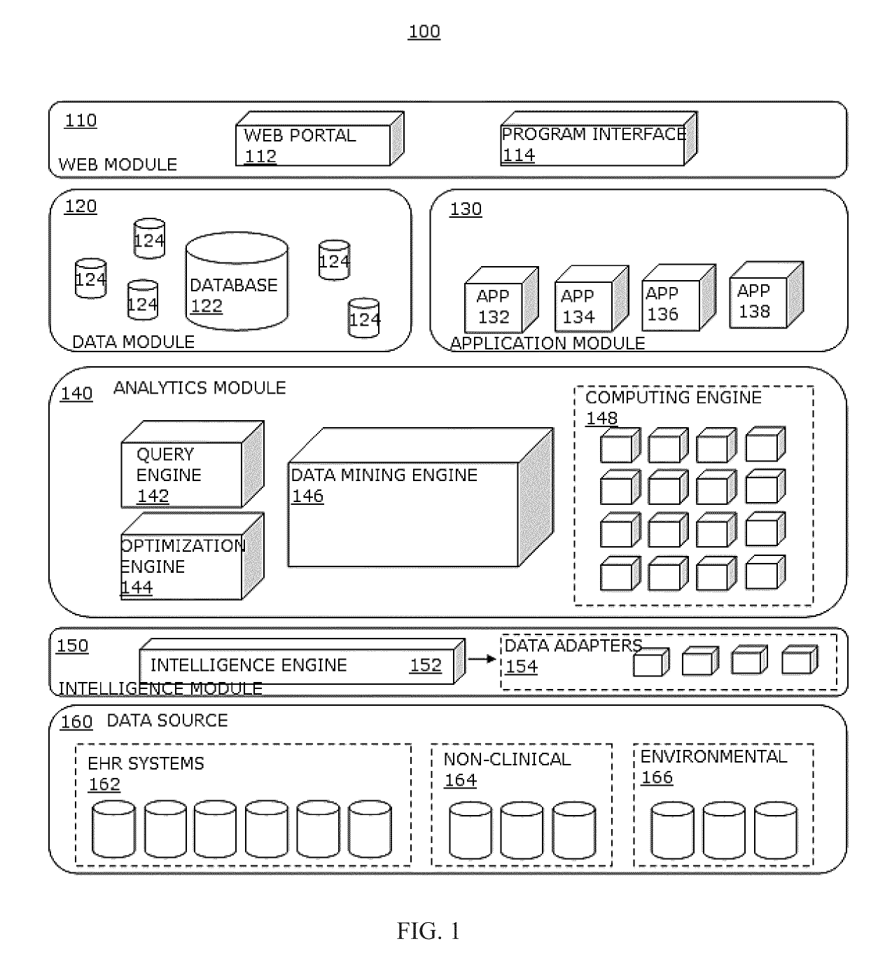

FIG. 1 illustrates a system 100 for analyzing health care data according to one or more embodiments illustrated herein. System 100 will be described in greater detail with the description that follows. System may be provided via a Service Oriented Architecture (SOA). System may be provided as a Platform as a Service (PaaS) and may be presented as and use facilities associated with cloud-based computing. System 100 may include a web module 110. The web module 110 may include a web-based portal 112 and a program interface 114. System 100 may include a data module 120. Data module 120 may include a database 122 and data storage systems 124. System 100 may include an application module 130. Application module 130 may include one or more applications 132, 134, 136, and 138 that are suitable for being run on a server and/or a computing device such as a personal computer or mobile computing device such as a smart phone. System 100 may include an analytics module 140. Analytics module 140 may include a querying engine 142, an optimization engine 144, and/or a data mining engine 146. Analytics module 140 may further include a computing engine 148 that is carried out on a distributed network. System 100 may include an intelligence module 150. Intelligence module 150 may include an intelligence engine 152 and data adapters 154. System 100 may include and/or be in communication with data source 160. Data source 160 may include electronic health records (EHR) systems 162, non-clinical data sources 164, and environmental monitors 166, mobile application databases, smartphone applications, and/or any other data source.

Web module 110 may be provided to support the end user experience, meaning the information and/or programs that the end user interacts with. These end users may be, for example, hospital administrative staff, health care providers, insurance providers, and any other person and/or organization that a program interface 114 may be desired for. The web module 110 may be user-accessible via any computer with an internet connection. Security of data in motion may be provided via login credentials, an enterprise-grade firewall, and SSL connectivity. Visual design and user experience may be carefully curated to fit the workflow of institutional end users. In one or more embodiments, the web portal 112 and/or program interface 114 provide a clear, easy-to-use, highly-functionality, and responsive interface that the end user can quickly learn with limited support. Additionally, the user experience may be designed to entice the user to ask more questions via program interface 114 and then be provided with one or more features that provide an answer to the user. Summary charts and/or other display outputs may be provided via the program interface 114 to the user in the web module 110. These summary charts may include revenue and/or quality of care impact information.

The data module 120 may be provided for storing and allowing ease of retrieval of data accessible by the system 100. The data module 120 may be configured to quickly store and retrieve large-scale data stored across a secure, distributed, multi-computer environment. To achieve this capability, the data module 120 may use two separate database systems, database 122 and database 124. Database 122 may be based on a NoSQL database management system, storing data by key-value pair or another NoSQL structure to enable maximum horizontal scalability and rapid information retrieval for analytics. Database 122 may be where the majority of the computations occur within the data module 120. The secondary database 124 is based on a relational database model and may be used as a data mart to service the web module 110. This secondary database 124 enables the data module 120 to be compatible with most commonly-used reporting and business intelligence technologies, including some of those in use within the platform's web module 110. One of the advantageous aspects of the dual database approach is that system 100 achieves compatibility with common reporting systems through use of relational database 124 to store results, but have the low-latency, high-availability, high-transaction volume, unstructured capabilities of the database 122 for the analytical heavy lifting.

Application module 130 is provided to store the unique functionality of specific product suites that may be provided with system 100. Additionally, the application module 130 is further configured to coordinate computing traffic and thus enable the queuing of jobs that depend of the facilities of other tiers within system 100. As best practice supports, the application module 130 creates a layer of separation between the data module 120 and all other layers within the system 100.

Analytics module 140 includes the querying engine 142, optimization engine 144, data mining engine 146, and computing engine 148. Analytics module 140 provides the intelligence module 150 with the intelligence it needs to adapt to varying data sources via machine learning algorithms. Once raw data is assessed in coordination between the analytics module 140 and intelligence module 150, it is then stored to the data module 120. The analytics module 140 supports the on-demand needs of specific application suites and both manual and automated batch processing for larger jobs. It is advantageously provided that analytics module 140 includes the querying engine 142 and the data mining engine 146. The query engine 142 is leveraged by the system 100 when the user (or application) knows or is able to determine exactly what is being sought in the data. An example of when the query/statistics engine is used would be when a user performs a search to identify all diabetes patients under his system's care that are over 13 years old and have elevated blood glucose levels as of their last test. The user (or application) knew exactly the information being sought, and the query engine can return that critical information accordingly.

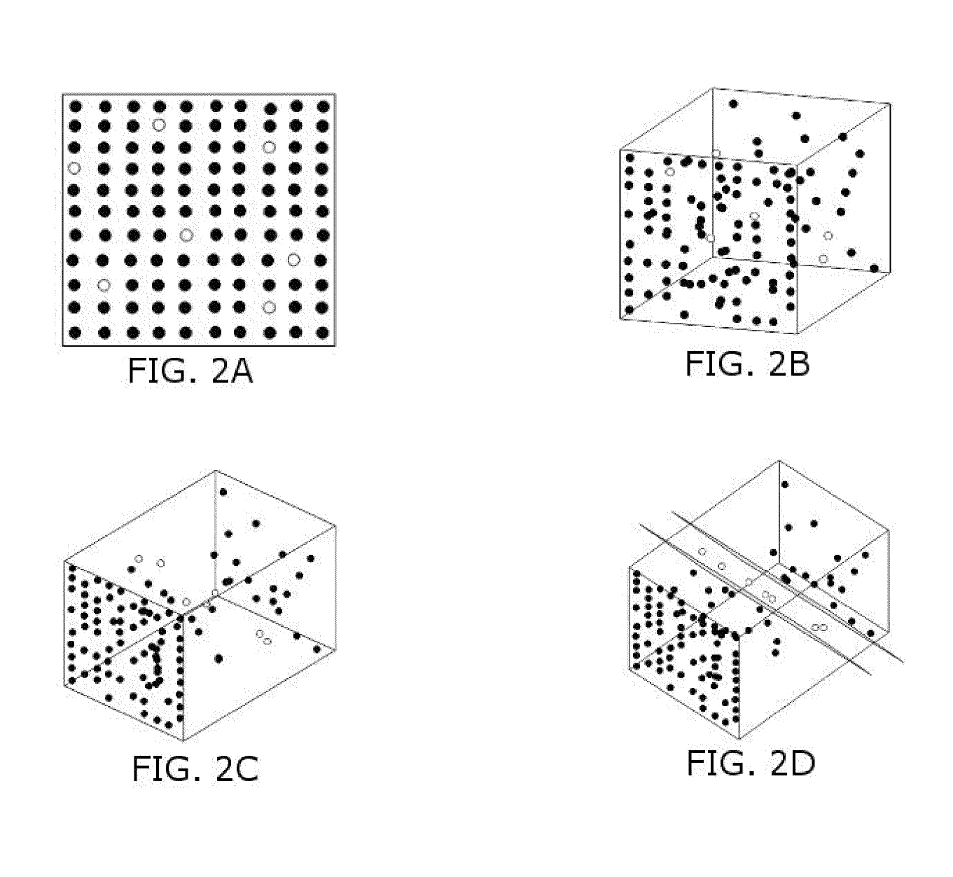

Unlike the querying engine 142, the data mining engine 146 is leveraged when the user (or application) may be unsure about exactly what is being sought. As one illustrative example, a user may want to determine what factors are most influencing the cost of COPD care, and which patients are most at risk for an acute, high-cost event this year? The data mining engine 146 may perform multi-dimensional machine learning analysis to detect the key influencers impacting the target of the question. With reference to FIGS. 2A, 2B, 2C, and 2D, assume the colored-in dots represent the COPD patients served by a client that are going to have an acute, high-cost flare-up over the upcoming 365 days. With reference beginning at FIG. 2A and extending through FIG. 2D, it appears difficult to predict which patients will be high-cost and which will be fine. However, using the data mining engine 146 and analytics module 140, system 100 can detect patterns that would be impossible to identify using the query engine 142. Indeed, the high-cost patients in this illustrative example could be predicted since there was an underlying pattern all along. Additional information in regards to these features is provided herein.

Computing engine 148 may have a unique infrastructure that is supported by a distributed computing environment within the analytics module 140. If required, an unlimited number of computers (e.g. thousands) can be part of computing engine 148 in order to support computational demands.

The intelligence module 150 of system 100 is configured to support the complexity, variability, and inconsistency of EHR data sources. To achieve this ability, intelligence module 150 leverages machine learning to dynamically alter the systems' data adapters 154 to properly interpret and integrate EHR data from new, previously unseen systems. In other words, system 100 uses intelligence to learn how to read data from new EHR sources, thus enabling system 100 to rapidly work with all existing and yet to be developed EHR and other data sources.

One of the core novelties and enablers of the intelligence module 150 is the ability to read and interpret data from many disparate, heterogeneous sources. This is particularly advantageous because of the lack of current interoperability of EHRs. Furthermore, the process used by intelligence module 150 and disclosed herein sharply contrasts with the current status quo approach to attempt interoperability of healthcare data; health information exchange efforts have been based on developing complex standards that hundreds of vendors would need to adopt for truly meaningful exchange. Intelligence module 150 eliminates this need.

One advantageous aspect that enables the intelligence module 150 to achieve this capability is an embedded artificial intelligence system for schema mapping. Schema mapping is the process of identifying objects that have similar semantic meaning. For example, let's say that two EHR systems, EHR A and EHR B, store patients' systolic blood pressures.

Examples of the storage format of EHR A and EHR B are illustrated in TABLES I and II, respectively:

TABLE I
EHR A
xEMR.2412
140.2
138.6
104.2

TABLE II
EHR B
DIAG_BP_S
122.2
146.0
100.8

As can be observed from the data in TABLE I and TABLE II, it would be difficult to determine that these two fields contain the same type of information unless the EHR vendors were to provide the underlying schema for their data store. Unfortunately, most EHR vendors today do not reveal their schemas; these schemas are often considered proprietary. For the purposes of research, some organizations have hired large teams to try and manually merge data. However, EHRs generally contain thousands of fields, and even if one were to manually map two EHRs, there are thousands more out there using very different schemas. The manual approach to networking and integrating EHRs would not scale.

The conventional approach being pursued by the healthcare industry to enable interoperability is to create complex standards that attempt to capture the semantics of all data within a healthcare setting. This is undesirable because it does not achieve the underlying goal of creating true semantic interoperability; even if there were agreement on a standard data schema to use across the entire healthcare landscape, data coding practices would vary from one institution to another. Furthermore, even if the standards were effective in isolation, it would be incumbent upon the hundreds of EHR vendors to implement a filter to translate their current, proprietary schema into a message that adheres to these latest, complex standards. These standards may not take third-party data sources into consideration.

Due to the variability in EHR data formats, a rapidly changing landscape, and the entry of third-party personal health applications that collect data that may be relevant to future patient care, system 100 has created a novel approach to the EHR data integration and networking challenge.

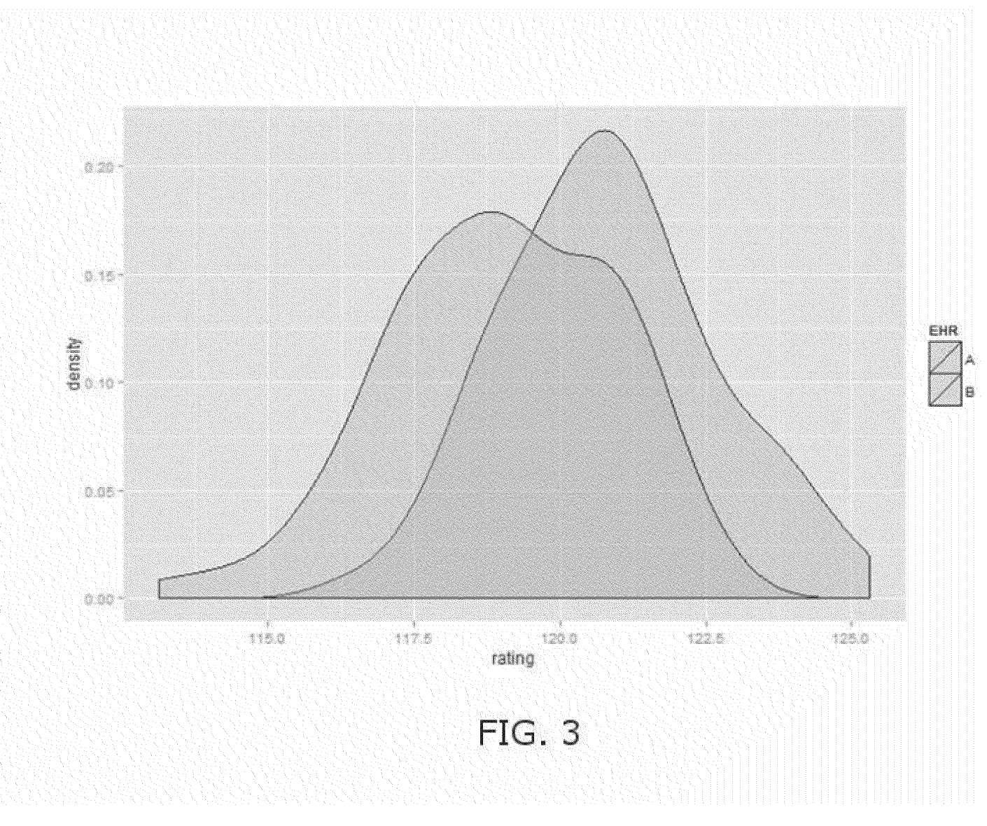

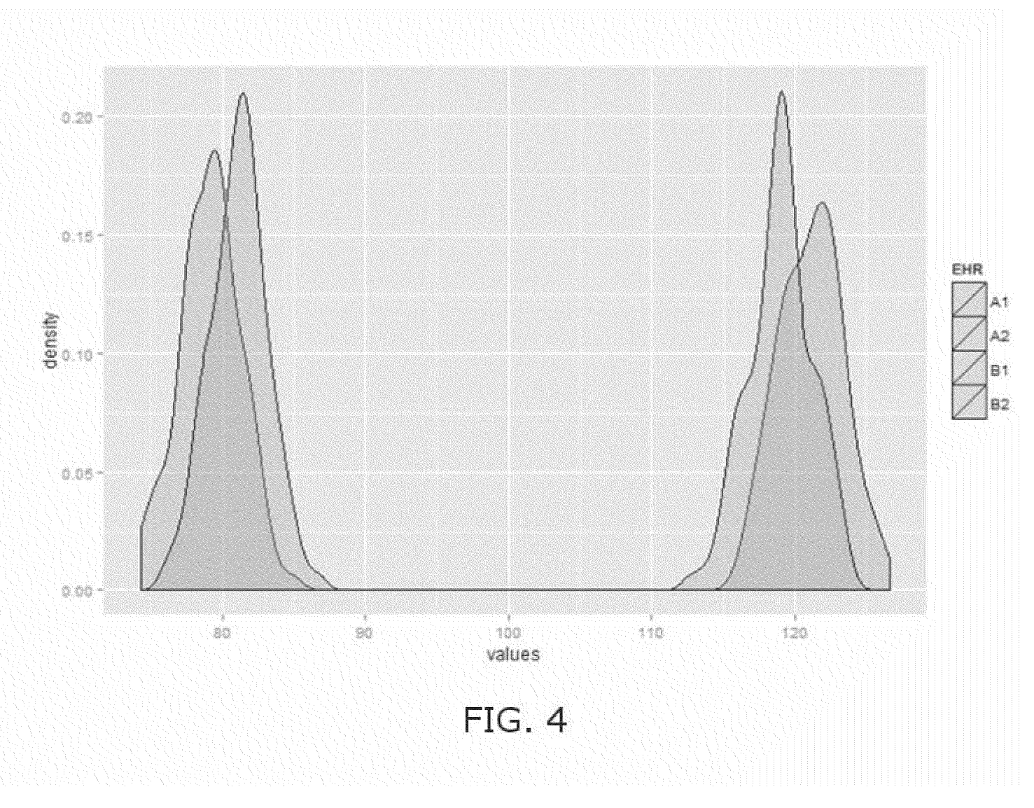

It would be difficult to infer from TABLES I and II that each of the TABLES represent the same underlying semantic concept: systolic blood pressure. However, the intelligence module 150, which performs extraction, transformation, and load (ETL) processes on data, is configured to leverage analytics module 140 to apply one or more computations, including machine learning methods, to assess the data contents of the fields to help inform the transformation process of intelligence module 150. Intelligence module 150 may be better understood by viewing two frequency histograms it has been configured to generate of these fields, and overlay the results to compare for a match value. As one illustrative example, frequency histograms of TABLES I and II are illustrated in FIG. 3.

As indicated by the overlap, the two fields contain values that follow similar distributional characteristics. The intelligence module 150 may be configured to expand the problem to include more than just one variable, such as, for example, to include diastolic blood pressures. In such a situation, a frequency histogram for TABLES I and II would be illustrated in FIG. 4.

As observable by the plots in FIG. 3 and FIG. 4, fields containing similar information between EHRs automatically “clump together” when the intelligence module 150 observes their frequency distributions. By computing the empirical similarity between disparate fields contained across multiple, disjoint systems, the intelligence module 150 can effectively and semi-automatically infer relationships between a plurality of EHR data sources and how such sources, and the data and/or metadata they contain, may map to one another and/or to some reference standard. It should be noted that the use of frequency distribution in this example is meant to help illustrate the core concept; in practice, the process of mapping, as disclosed herein, is more complex.

The intelligence module 150, with the analytics facilities provided by analytics module 140, may have one or more schema mapping prototypes built, each of which uses a different machine learning approach to address the same problem. Each approach is adaptable to numeric, textual, sound, and graphical data contained within EHRs. In a first approach, the analytics module 140 is configured to provide an unsupervised learning algorithm for use by intelligence module 150 that semi-automatically determined how fields map between systems without having previously seen similar data. This approach may be carried out on any of the computing engine 148. In a second approach, the analytics module 140 is configured to provide a supervised learning algorithm. This latter approach requires that the algorithm train using a control data set before it can be ran on new data.

Beyond EHRs, data outside of the clinical setting is likely to start impacting the care delivered within the clinical setting in the years ahead. For example, third-party smartphone applications are storing patient data at levels never before observed. However, this valuable information that can help inform care currently has no way of entering the clinical care setting in a consistent manner. Many applications are each storing unique aspects of patient health in different ways, creating data silos in a way not too dissimilar to the dilemma observed with electronic health records. The system 100 disclosed herein is particularly advantageous for addressing these disadvantages, particularly with various features provided via intelligence module 150 in concert with analytics module 140.

Similar to third-party smartphone applications storing patient information, Pay-For-Performance (P4P) contracts are quickly integrating outcomes into the measures that impact provider revenue, a movement becoming known as pay for outcomes (P4O). Herein, the terms “P4P,” “P4O,” “at-risk contract,” and “value-based payment” are used interchangeably. Often, the factors controlling patient outcomes are not determined by actions taken within the care setting. For example, in the case of COPD, high-cost acute healthcare events may be triggered by high ozone concentrations in the patient's environment; the health of the patient may be acutely impacted by air quality. Environmental data 166 may be gathered for detecting this information and integrated it with the patient's other health records, based on patient location. Other non-clinical data may be read by the non-clinical data reader 164, such as, for example, claims data, including those related to health insurance and/or malpractice. Using this additional information, system 100 can factor these external measurements, such as air quality, population density, morbidity charts, and the like into the analysis and output that system 100 provides.

Additional non-clinical data may include geographic distance between a patient and the nearest supermarket and/or food source and geographic distance between a patient and their primary care provider. Additionally, non-limiting examples of additional non-clinical data may include the color car that the patient and/or care provider drives, mortgage and/or other real estate records, tax liens, marriage, divorce, and other social data, data from third party vendors such as, for example, Nike® Fuel Band, data from one or more credit bureaus, motor vehicles data, data from smartphone applications, information from the United States census, geographical information, traffic information, weather, data from the US Bureau of Labor Statistics, and data from social media sites such as Facebook, LinkedIn and the like.

System 100 is provided to assess each data field (and/or values belonging to a common key) for attributes that are indicators of a primary key. For example, in one or more embodiments, system 100 monitors the percent of values that were unique within a field/key and percent missing values. System 100 computes a ‘parent key likelihood score’ for each field/key.

System 100 then constructs a listing of all pairwise permutations of fields (or keys) between all data (tables) provided. System 100 then removes pairwise permutations whereby the first field/key in the pair has a low parent key likelihood score. System 100 then removes pairwise permutations whereby the second field/key in the pair has a high parent key likelihood score. For the remaining pairs, system 100 then computes the percentage of values in field 1 that also appear in field 2. This may be termed a similarity score. System 100 then computes the average number of times a value that appears in both field 1 and field 2 is repeated in field 2. This may be called a repeatability score.

For each pair, system 100 then performs a computation on the similarity and/or the repeatability score to determine key relationships between tables. In one or more experiments, system 100 received very good results by simply filtering out all pairs with a similarity score less than 0.5. The remaining pairs were all valid relationships between the provided data tables. In one or more experiments, it was also determined that sorting the similarity score in descending order was useful in detecting valid relationships between fields.

### Applications

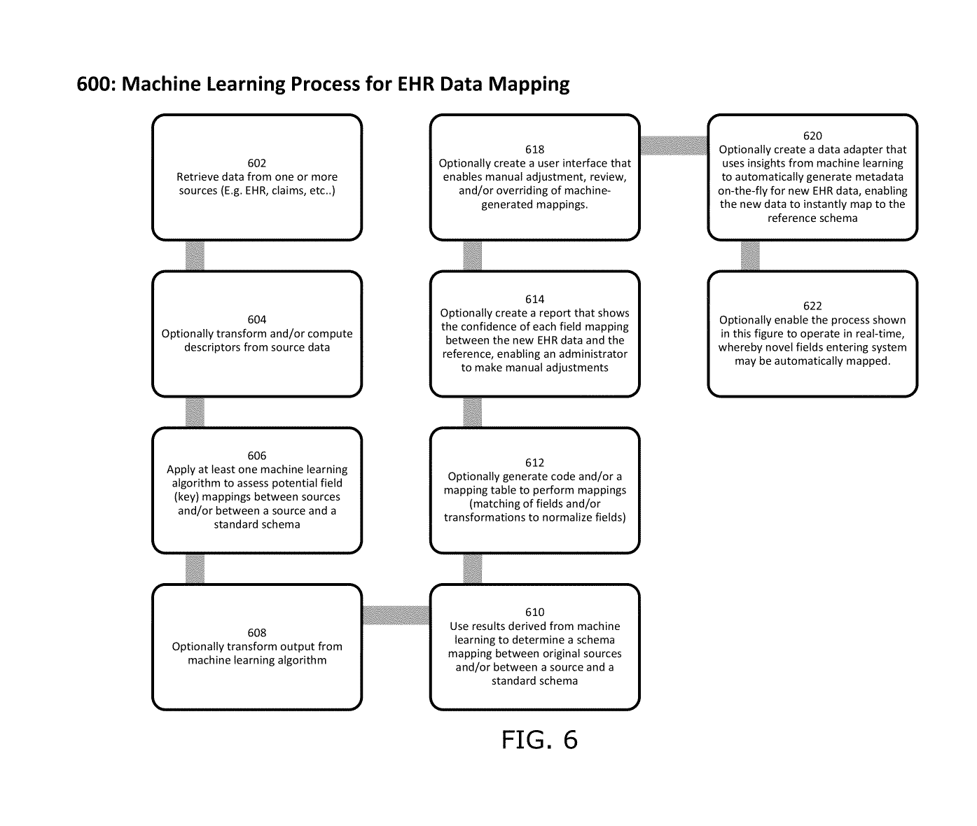

Application module 130 is provided to store the unique functionality of specific product suites that may be provided with system 100. These product suites may be embodied in the applications 132, 134, 136, and 138 provided in the application module 130. The following functionalities may be addressed by any of these applications: Applications may also be further described with reference to the flowcharts of FIGS. 6 through 14.

### COPD Profiler

The COPD Profiler may be used for institutional healthcare provider CFOs, directors of care coordination, P4P contract negotiators, health insurance incentive planners, and COPD smartphone application manufacturers. Chronic Obstructive Pulmonary Disease (COPD) is a costly, chronic respiratory disease. When the disease is properly managed, costs can be kept low. However, when the disease is not properly managed, treatment costs skyrocket. By surveying the patient population served by a client, system 100 can detect which patients are at risk for imminent high-cost COPD acute care events, providing early warning so care providers may intervene to get the condition back under control. System 100 enables near real-time validation of intervention effectiveness.

In a typical example, a provider will be able to identify revenue bottlenecks in real-time. For example, the application suite may visualize, in near real-time, where the institution stands across specific clinical quality measures that have the greatest impact on its revenue. The application suite may understand the prevalence of disease within its care population, enabling it to assess institutional risk across the P4P contracts it enters. The application may reveal the root cause of revenue being placed at risk, enabling the system to take action to ensure the revenue comes through the door. The application may list the specific patients in need of attention that have been overlooked. The application may recommend specific interventions. By clicking a single button, many of these interventions can automatically be put into motion. The application may be able to reveal in near real-time whether the interventions are having an impact on care quality, cost control, and revenue.

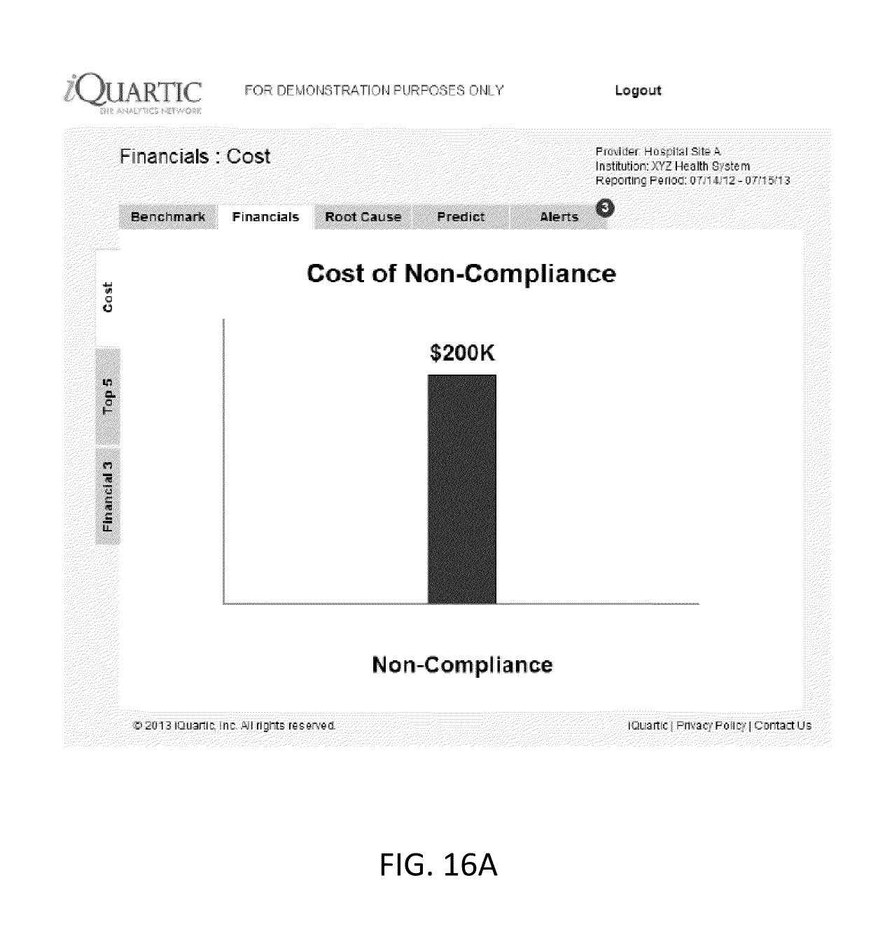

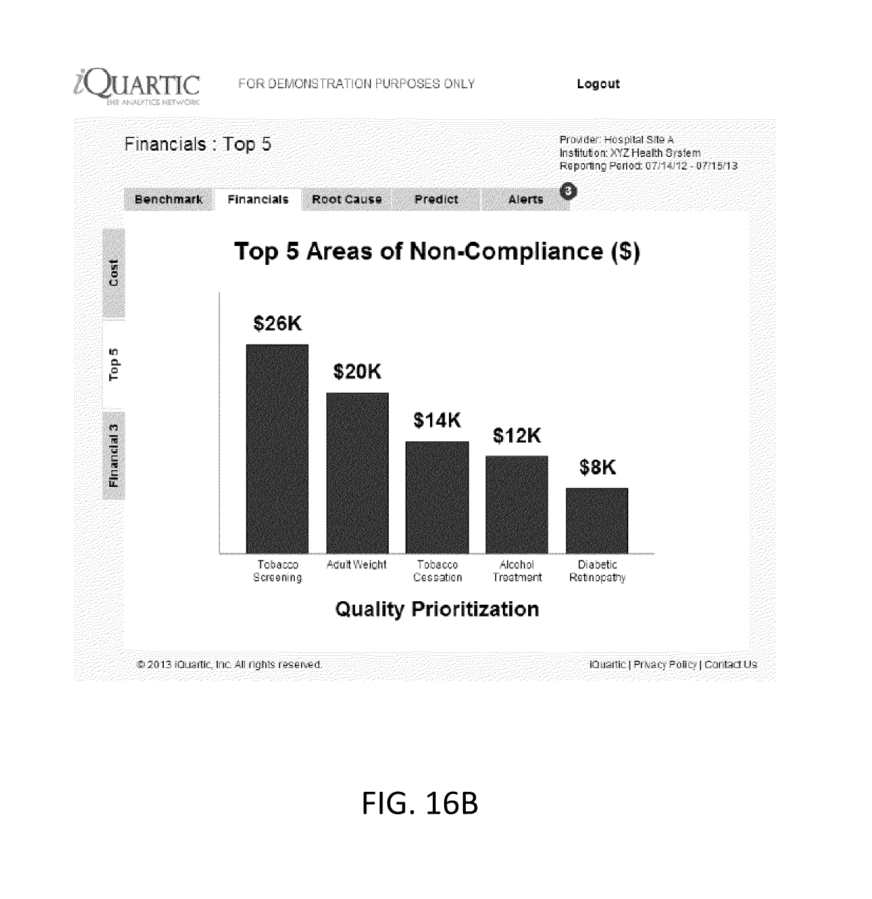

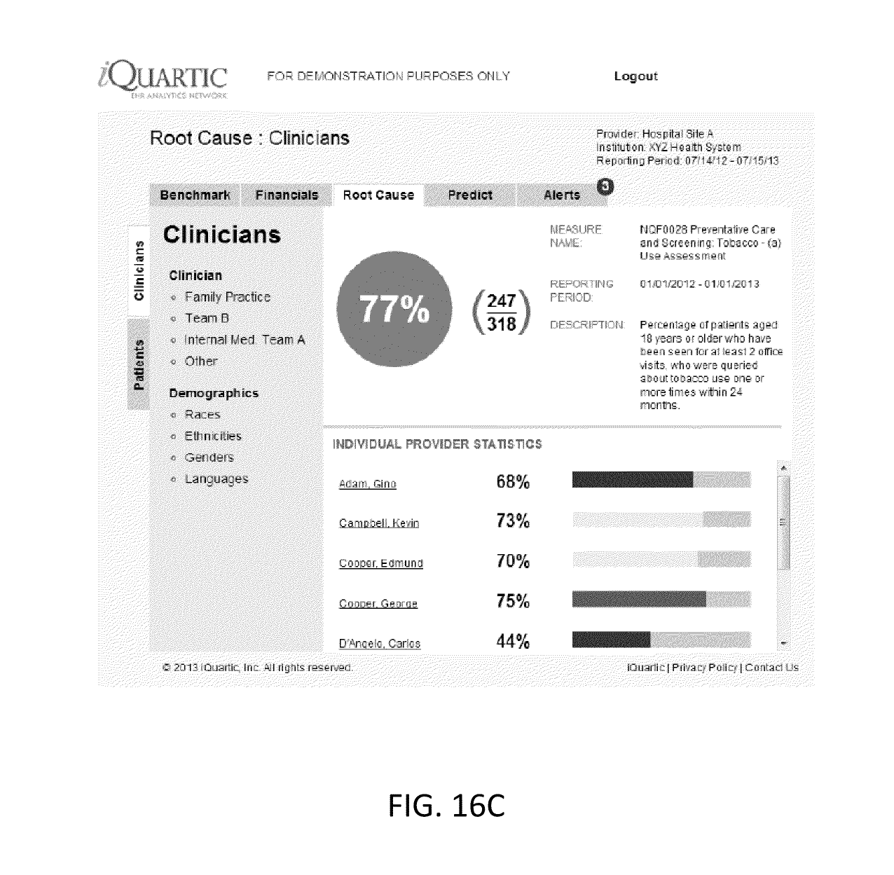

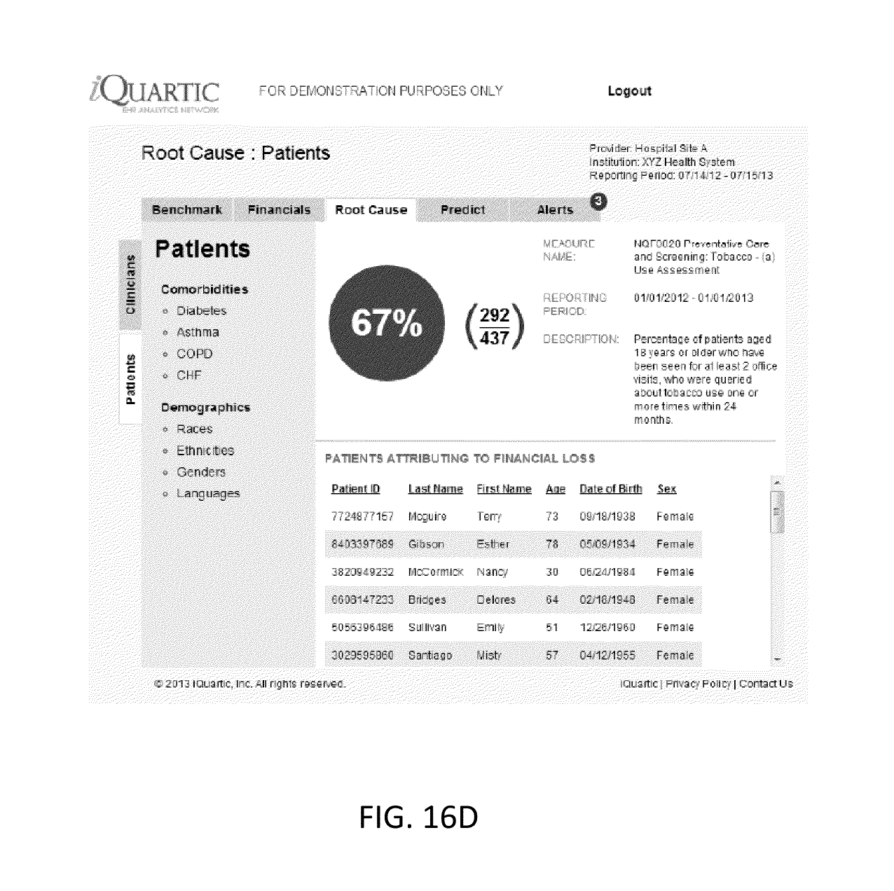

As an illustrative example, the providers' finance officer securely logs into the system 100 through web portal 112 with an internet connection. Upon logging in, one of the first prompts on the web portal 112 that the finance officer encounters is a graph, an example shown in FIG. 16A, showing how much revenue the service provider system stands to lose this year due to non-compliance across P4P contracts. In this example, finance officer sees that the system is on track to lose one million USD in revenue this year.

Finance officer wonders what specific contractual obligations are causing the system to miss out on this revenue. Finance officer clicks on the graph to drill down. On the next screen, an example shown in FIG. 16B, finance officer is presented with a listing of the specific obligations the system is not hitting, and how much revenue is tied up in each. The list and associated plot may be ordered from most to least costly issues. Finance officer sees that there is one specific clinical quality measure, a screening test that is accounting for 60% of the revenue lost.

Finance officer now wants to know what employee, personnel, or department is accountable for this measure. After clicking on the specific measure, finance officer is presented with a screen, an example shown in FIG. 16C, revealing the rates at which departments and clinicians are performing this screening when indicated. Finance officer sees that some clinicians are very good and nearly always provide the screening when indicated. However, finance officer also sees that there are some specific clinicians who nearly never screen. Alongside their line on the screen, finance officer may see an estimate of revenue impact the individual has on the organization due to lack of compliance with this metric. Based on this finding, finance officer shares this screen with the clinical director.

The clinical director receives an email and logs into the system 100 from her home computer via web portal 112. The clinical director determines that there are many clinicians who are not properly performing the screening and this represents a systemic issue. The next day, the clinical director decides, at the suggestion of system 100, to schedule a training session to help refresh clinicians on the indicators and importance of the screening. In addition to the refresher, with a single button click, the system 100 automatically implements another intervention, messaging each clinician of the specific patients that need to be screened, but who weren't. While the clinical director is logged in, the director can also click on any specific clinician to examine which patients cared for by the clinician require a call to be screened.

A clinician who works at the health system provider was one of the individuals impacted by the intervention. The clinician logs into the system 100 via web portal 112 and sees a patient screen, an example shown in FIG. 16D. For clinician, there are two patients he failed to screen who he needs to contact. Alongside the patients, the clinician may see an estimate of the impact not screening may have on the organization, making the importance of screening transparent. On each patient's next visit, the clinician provides the screening, and records it into the system's EHR.

At some time later, finance officer logs into the system 100, views a screen similar to that shown in FIG. 16A, and determines that revenue at risk for being lost due to non-compliance across the system has dropped substantially. The system 100 has closed the loop, providing a direct revenue-to-quality feedback loop with real-time validation. The system 100 thus provides increased revenue across P4P contracts, increased revenue from more patients due to tangible evidence of quality care/referrals, increased revenue due to better reimbursement negotiations, increased care quality, decreased errors and omissions, decreased risk, decreased uncertainty come year end, and system-wide quality-to-revenue transparency.

### Clinician Profiler

The Clinician Profiler may be used for institutional healthcare provider Chief Financial Officers or other finance persons. Clinical Profiler may also be used by clinical personnel. Pay for performance (P4P) contracts are placing new demands on providers to improve healthcare delivery efficiency, or else suffer direct financial repercussions. Managing the efficiency of care being delivered across all practitioners at an institution is critical to meeting the demands of P4P. However, detecting non-compliance is only part of the solution; effective drill-down and interventions are required to make an impact. The clinician profiler application may be part of application module 130 and provides an automated, self-policing intervention mechanism to effectively improve efficiency and reduce costs across clinicians. The application functions by creating incentives that leverage the competitiveness of health care practitioners to increase quality and revenue in a measurable way.

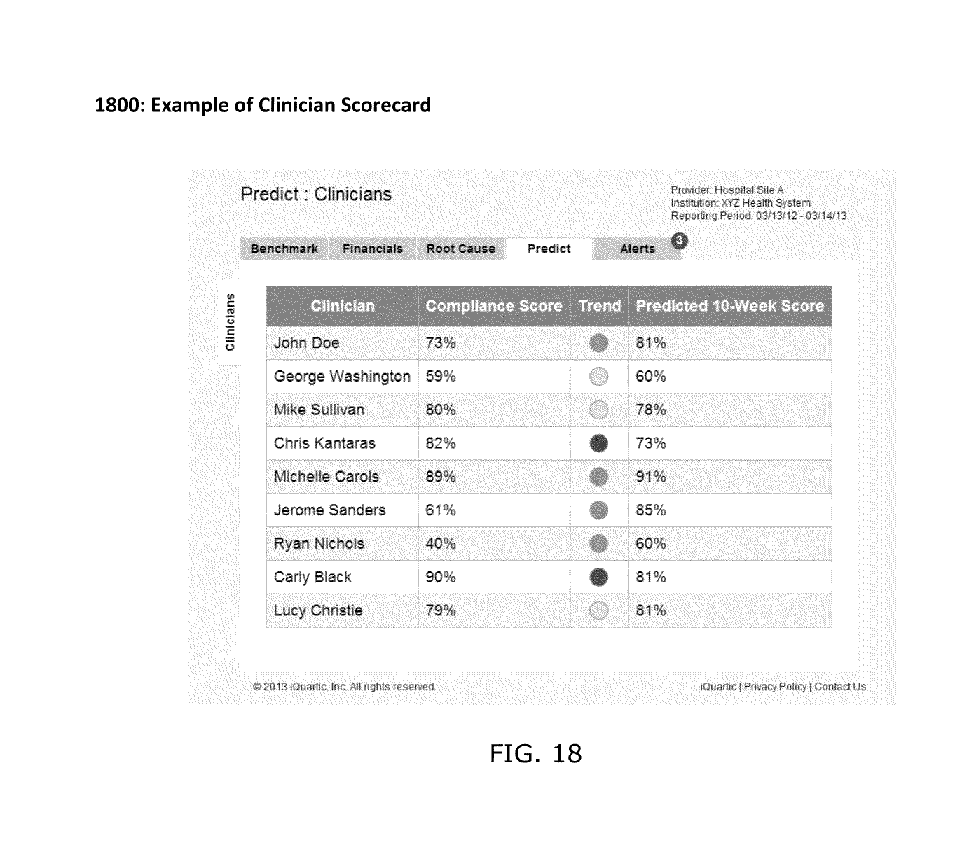

In one illustrative example, consider a primary care physician at a large, urban hospital. Each morning when she arrives at work, the provider receives an email and finds a scorecard extract that says that she is ranking second in the care of cardiac patients, but ranks seventeenth in her care for asthma patients versus her peers. The provider clicks on a link, then securely logs into the clinician profiler application from any computer with internet access. Upon logging in, the provider is shown a screen, an example of which is shown in FIG. 18, that visually displays how she compares to her peers across specific benchmarks that have been determined to have the greatest financial impact on the institution and the quality of care it provides. Identifiable information of other providers may be obscured. Further, lists providing comparisons may be sorted. Using engaging traffic lights and visual gauges, the web portal 112 shows the provider exactly what aspects of care are causing her to rank as she does in different areas.

The provider wants to understand why they rank seventeenth in asthma care versus their peers. By clicking on the asthma rank, the provider can see a more detailed view of the measures factored into the asthma rank. Furthermore, the provider can see where each of her peers rank across each quality measure under the asthma heading, without their identities being revealed. Provider now sees that she has not been prescribing an appropriate bronchodilation medication when it is warranted. Empowered with this information, the provider now heads to the clinic with a goal to elevate her ranking against her peers.

### Diabetes Profiler

The diabetes profiler application may be provided for institutional healthcare provider CFOs, directors of care coordination, health insurance incentive planners, and smartphone application manufacturers. Diabetes is another chronic disease that yields high-costs of care if not properly controlled. The diabetes profiler, similar to the COPD Profiler, is a web-based product that profiles diabetes patients. The system counts likely diabetes patients (including undiagnosed), assesses population diabetes management, comorbities, benchmarks, managements areas requiring attention, and patient risk scores.

### Patient Cost Profiler

The patient cost profiler application mines hospital billing data for anomaly patterns. Specifically, the technology detects patients, clinicians, departments, and sites that have unusual spending behavior versus peers after controlling for the nature of the disease profile being served by the unit. For example, is there a specific department that is prescribing higher cost medications when generics are being used to treat similar patients in similar departments?

### EHR Data Auditor

The EHR data auditor is an application that assesses quality of EHR data, identifies costly errors, and provides recommendations for clean-up to increase revenue, reduce costs, and/or improve quality. Additionally, the technology identifies data entry errors that yield institutional risk, including missing and misreported data.

### ER Profiler

The ER profiler application predicts which patients are likely to utilize Emergency Department services over the upcoming 365 days. Additionally, the ER profiler application predicts which patients are likely to be re-admitted to the emergency room and/or hospital following release from the hospital. The application provides patient-specific recommendations to prevent these emergencies.

### Patient Profiler

The patient profiler application provides a 360-degree view of patients based on aligning their co-morbidities with P4P contractual obligations. The product enables institutional providers to prioritize and coordinate how increase care delivery impacts performance across the entirety of the patient population.

### Geospatial Profiler

The geospatial profiler overlays co-morbidity heat maps on top of geographic maps to enable institutional care providers and public health experts an ability to identify clinical high-cost hot spots and underserved areas. For example, areas of clinical high-cost may be mapped against a given geographic service region. The service providers could then map against the location of service providers and other data sources such as non-clinical data 164 or environmental data 166 to determine if there is causation related to the high-cost spots. This data may then be used to recommend a treatment for a given patient, patient profile, and/or area. For example, if a given area has a high concentration of patients having skin cancer or other sun exposure related ailments, a hospital could mail alerts to patients within that given area informing them of the benefits of sunscreen. Additionally, the hospital could adopt additional measures for informing patients of the benefits of sunscreen, such as, for example, including a sunscreen question on a patient intake form or a screening process for skin ailments in a given area. The additional screening could be based on, for example, a notification that a given patient is from the high-cost area associated with patients having sun exposure related ailments so that the additional screening would only be carried out for selected patients most likely to have sun exposure related ailments.

### Developers Platform

The developer's application enables outside developers and researchers to build novel predictive models, reports, and applications using EHR data, publish applications in the system 100, and then license the applications to institutional care providers and other users of the system 100.

### EHR Application Store

The EHR application store is a secure, cloud-based store that enables institutional care providers, insurers, and other users of system 100 to purchase additional add-on applications that analyze and report on their organization's EHR and other health data in novel ways. System 100 may act as the store/broker and take a percentage of the licensing fees due the developer for use of developer's application.

### Patient Timeline

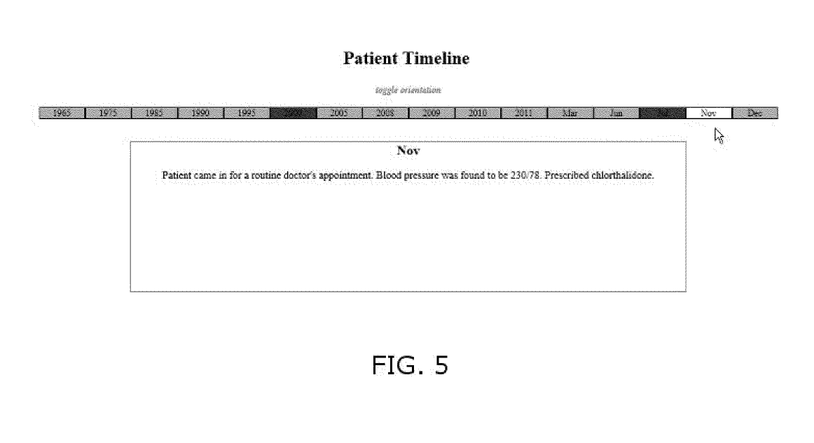

One or more applications may be provided that displays, on web portal 112 or other aspect of web module 110, a timeline of care and/or treatment history of a patient. In this manner, longitudinal records may be used that are easier to visualize. A listing of time-related elements from left to right or from top to bottom, where each successive element in the listing is a time greater than the previous element. In the one or more embodiments disclosed herein, time elements on the timeline may be of equal or unequal increments. Timeline elements may be linked to discrete events in the EHR records, whereby clicking on a section of the timeline may display EHR data related to the point in time selected from the timeline. Alternatively, EHR records may be displayed without clicking on the timeline; EHR records will be visually associated with discrete points on the timeline via arrows, colors, boxes, or other means. The timeline may optionally display varying colors, bullets, or other indicators to indicate the presence or absence of information relevant to patient and/or population healthcare. Clicking on an indicator may optionally display additional information related to the data underlying said indicator. An example of one or more timelines is illustrated in FIG. 5.

### EHR De-Identification

EHR data generally contains sensitive information that is protected by HIPAA, HITECH, and other legislation. There are two currently accepted approaches to De-Identification of HIPAA data: Safe Harbor or Expert Determination. Safe Harbor requires removal of 18 types of identifiers found in the data, including names, geographic subdivisions smaller than a state (including zip code in most cases), dates (except year), and the like. Under Safe Harbor, each of these identifiers must be removed entirely. For example, if even one identifier appears in isolation on the record, for example, zip code, the data is considered identified and remains protected under the HIPAA Privacy Rule. Unfortunately, obscuring identifiers is not as simple as removing a field, (E.g. —removing a “name” field). Rather, identifiers may appear in unexpected fields, such as in clinician narratives.

According to one or more applications provided herein, the de-identification application creates a framework to implement either Expert Determination or Safe Harbor in near real-time. As disclosed herein, methods and system for detecting sensitive information buried in both structured and unstructured data are provided. Upon identification of possible identifiers, the system enables statistical methods and/or removal methods to be applied. System 100 is configured to permit public users to perform analysis on sensitive (personally-identifiable data) without having the ability to see the sensitive data. Analytical results are checked to ensure they are non-identifiable.

System 100 may detect sensitive data by searching for header field names and compare to dictionaries and databases of known sensitive data, column values data and compare to dictionaries of known sensitive data, column values structure, meaning to perform regular expressions to detect presence of various substring structures, and supervised machine learning that uses researcher identification of known sensitive fields/values to “learn” patterns between sensitive and non-sensitive data, then apply such knowledge to new data for which researcher identification is not required. Supervised and/or supervised learning algorithms may be used to detect fields at risk for containing sensitive information.

System 100 may be configured to obfuscate sensitive data in a variety of ways, including but not limited to:
Blackout—replace value with a constant (e.g. —NA, *****);
Recode—replace values with random substitute values, ensuring that originally matching values are given matching substitute values;
Jitter—add a suitable amount of noise to the values (e.g. a random linear transformation); and
   Aggregate—apply a function that aggregates personally-identifiable data such that the result of the aggregation function is no longer personally-identifiable. For example, while birth dates are considered sensitive, average of two or more birth dates is not. The average (mean) is acting as an aggregation function.

Levels of Granularity Targets for Obfuscation may be provided by System 100 in the following ways:
Field (key) level—Apply obfuscation to the entire field (key);
Cell (value) level—Apply obfuscation to the specific cell (value) that contains sensitive data; and
Sub-cell level—Apply obfuscation to a sensitive substring or value within a cell

One approach to programming in this capability is to search field values for sensitive data based on any combination of the following:
Known dictionaries of sensitive data;
Substring structures (date formats) indicative of sensitive data;
Machine learning, whereby a machine learning algorithm was trained to classify sensitive versus non-sensitive data;
Create a count by field of the number of sensitive cells discovered;
Compute a percentage of sensitive data for each field (sensitive cells over all cells);
If a field contains an arbitrarily high percentage of sensitive data (say >5%), apply obfuscation to entire field;
If a field contains a low percentage of sensitive data, create alert for manual review; and
Apply cell or substring-level obfuscation.

### Analytics Crowdsourcing

System 100 may be provided to enable public developers and analysts the ability to analyze EHR data without interference from HIPAA/HITECH regulations. This technology may be effectuated by several steps. For example, developer is provided a metadata view of the EHR data repository that reveals the fields, tables, and basic measures (means, sums, NA counts, data type) available for analysis. This view is made available via a web interface. In addition to metadata, the developer may be able to view de-identified patient data. HIPAA-protected data will not be available for viewing. However, analytical requests submitted by the developer may operate on HIPAA-protected data. The developer can submit analytical requests to the system 100. In one embodiment, this is achieved via a textbox and a submit button on a web page. The analytical request may be as simple as a query that counts the number of diabetic patients in a region or as complex as a neural network that is being trained on how to predict influenza epidemics. The analytics module 140 receives, reviews, and runs appropriate data processes based on the analytical request. Processes may be run against the complete, real-time EHR data set.

Prior to returning a result, the analytics module 140 checks to ensure no HIPAA-protected data are being returned. If HIPAA-protected data is detected, a message is returned to the developer indicating that the result cannot be returned. Otherwise, the analytical results are returned to the developer.

One of the key novelties disclosed herein is the ability to enable public users to analyze, but not view, HIPAA-protected information. The key insight that enables this technology to work is the fact that personally identifiable information, when ran through an algorithm, often yields a result that is not identifiable. For example, the two ages, 92 and 95, are considered sensitive (PII) under the HIPAA privacy rule. However, if we run a simple algorithm on these data, for example, a summation, the result of applying this function is no longer considered PII under HIPAA. Yet, this analytical result can be vitally important to researchers. This is a reason why system 100 is a critical piece of the future healthcare system. It is the technology that will enable top diabetes, COPD, cancer, and other researchers across the globe to analyze live EHR data in real-time without the need to overcome HIPAA challenges.

The EHR analytics module 140 together with application module 130 enables the developer to store, share, and sell algorithms and results developed from the above analysis with any other user the of system 100. Furthermore, such algorithms can then be used to score new data.

The system 100 permits developers to package their insights (results, algorithms, processes, etc) as an application within the system using application module 130, then to sell the application or use of the application to other users of system 100. For example, an HIV researcher in Africa may use the above described system 100 to construct a predictive model to detect which patients will likely become HIV-positive in the next 365 days (the algorithm received patient information and outputs a probability score). The researcher may submit this algorithm to the application module 130 and license use of the algorithm to hospitals, health systems, and other users of system 100.

In one or more embodiments, developers may license use of their application via a fix price, pay-per-use, subscription, or another pricing system. Users who license the application may apply the algorithm and/or insights to their own EHR data within the system 100.

### Security

The data stored and analyzed within the system 100 is expected to contain Personally Identifiable Information (PII) protected under the HIPAA Privacy Rule and the HITECH act. In the design of the one or more processes disclosed herein, multiple redundant layers of security may be embedded to ensure full compliance with regulatory requirements. According to one or more embodiments, the following layers of protection may be employed:
1. Data in-motion may be protected by Secure Socket Layer (SSL) encryption;
2. Data at-rest that falls under HIPAA restrictions may be stored to separate encrypted data partitions; each encrypted partition may be assigned a unique key;
3. System 100 may reside within a virtual private cloud (VPC), the VPC residing behind an enterprise-grade firewall. This cloud environment may achieve compliance certifications that include:
   a. SAS70 Type II
   b. PCI DSS Level I
   c. ISO 27001
   d. FISMA
4. Data may be automatically backed-up on a schedule. Backups may be encrypted as required;
5. A data audit trail may be archived and monitored;
6. Only appropriately authorized personnel may be permitted access to data on an as-needed basis; and
7. Data that requires removal from the platform may be securely erased according to DoD guidelines for secure data destruction.

### Information Flow

In one or more embodiments, the majority of data entering into the system 100 in early information gathering periods may be mostly from EHR systems. As previously discussed, EHR systems lack standards for how data is stored; each vendor, product, and implementation of product may be unique and customized to the site. Therefore, the system 100 has been designed to make few assumptions about the source and structure of the input data.

As data enters into the system 100, it may be archived in its native source format that is dependent on the source system. Once this data is stored, it may then undergo an intelligence process that transforms it into a cannonical, hierachical, semistructured data format based on JSON (JavaScript Object Notation) or XML. From this JSON/XML format, a secondary intelligence process occurs whereby the analytics module 140 works in conjunction with the Intelligence module 150 to generate attributes that act as a layer of machine learning-generated metadata to tag the probable semantic meaning behind data points. The data and new metadata are then stored to a NoSQL database as key-value pairs. Various data mining and other analytical processes are ran, with results being stored in a relational data mart used for reporting via the application server and web module 110.

One or more exemplary methods may also be employed herein and a non-exhaustive list follows. For example, a method of healthcare-related data analysis may be provided. The method may include collecting data from one or more electronic sources. The data may be from a non-healthcare or a healthcare source. The method may include generating metadata related to the collected data. The metadata may be used to map and guide transformations of said data. The method may include computing at least one metric from the data that may directly or indirectly be relevant to healthcare operations (including patients, healthcare providers, insurers, medical malpractice, pharmaceuticals, local, state, or federal governments, CDCs). The method may include enabling the retrieval of said metric by either a human operator or machine, whereby said human operator may be presented with a graphical user interface and said machine may be presented with an API.

Data may be collected more than one time, including continuously in real-time. Real-time may be at a frequency as often as every one millisecond. Machine learning may be used to generate metadata. The metadata may be used to map said data. Machine learning may be used to construct adapters to automatically map and transform data. Machine learning, data mining, artificial intelligence, and/or statistics may be used to compute the metric. Machine learning may be used audit data for accuracy and/or correctness.

The one or more methods may be made available as a Service-Oriented Architecture (SOA). Data and/or metrics may be queried and/or reported using industry-standard Business Intelligence technologies (e.g. Tableau). Metrics may be stored to a database. The metric may be queried alongside other data.

Information available to user (including data and metric(s)) may be different based on permissions and/or roles. For example, certain individuals may have access to certain data and performance indicators that other individuals may not have access to.

Distributed computing and/or the use of a MapReduce model, may be used to story, query, and/or analyze data. A user may perform a search, provided the user has permissions. Apache Hadoop may be used as a component of the distributed computing engine.

Temporal data may be displayed as a horizontal or vertical bar/timeline. Spatial data may be visually displayed on a geographical map, including but not limited to as markers or heatmap layers.

A method for integrating data relevant to healthcare operations may be provided. The method may include computing metadata for each data element. The method may include applying an unsupervised learning algorithm to the computed metadata. The algorithm suggests data elements' similarity to each other and/or to some standard. The method may include constructing mappings or transformations between data elements or the standard based on the results of the algorithm. The descriptors may be standardized. Probability of two data elements having the same semantic meaning is computed. Code (an adapter) may be generated to integrate similar data in the future without requiring subsequent use of an unsupervised learning algorithm.

A method for integrating data relevant to healthcare operations may be provided. The method may include applying a supervised learning algorithm on a reference data set to train said algorithm on how to map data fields/keys to reference data fields/keys based on analysis of values stored in data fields. The method may include constructing metadata for new data fields based on the output derived from applying said trained supervised learning algorithm to said new data fields. The method may include constructing mappings or transformations between data elements or the standard based on the results of the algorithm.

The probability of a new data field being semantically similar to a field in a reference data set may be computed. Output of supervised learning algorithm may be standardized. Code (an adapter) may be generated to integrate similar data without requiring subsequent use of an unsupervised learning algorithm.

A method for assessing financial impact of quality metrics on healthcare institutions may be provided. The method may include codifying rules/requirements of P4P/value-based/quality contracts. The method may include applying data against said rules. The method may include computing (or estimating) financial impact of care delivery. The method may include performing attribution (who/what is responsible). The method may include enabling roll-up and drill-down of results within hierarchies (geographic region, system, facility, department, clinician, patient, disease, root cause of disease). The method may include identifying a corrective measure. A means or manner to implement a corrective measure may be provided. Interventions and/or corrective measures may be assessed for effectiveness.

Crowdsourcing may be employed. In some embodiments, analyses of EHR and other data may be conducted by public users of the system, enabling users to build applications. Applications developed by users may be made available to other users of the invention for use on their data.

Each of the processes shown in FIGS. 6 through 14 may be employed by any appropriate device within system 100, and may require multiple devices and/or modules from system 100. Each of the processes disclosed herein may be embodied as computer programmable code in, for example, computing engine 148 and/or application module 130.

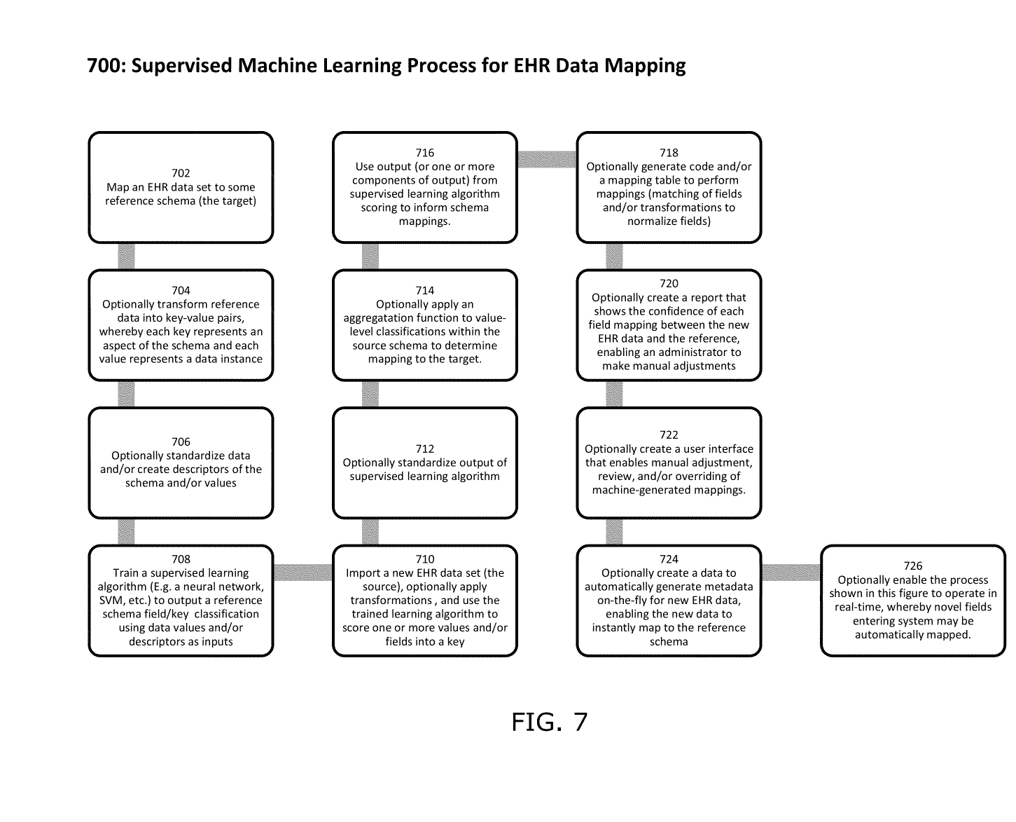

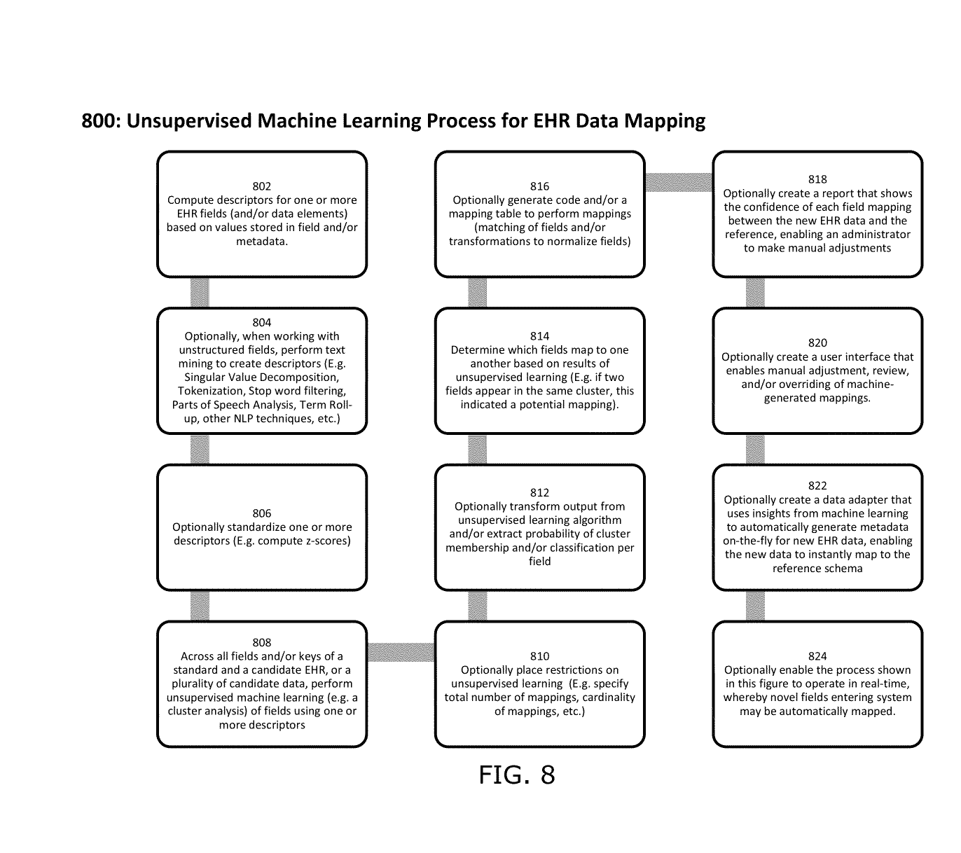

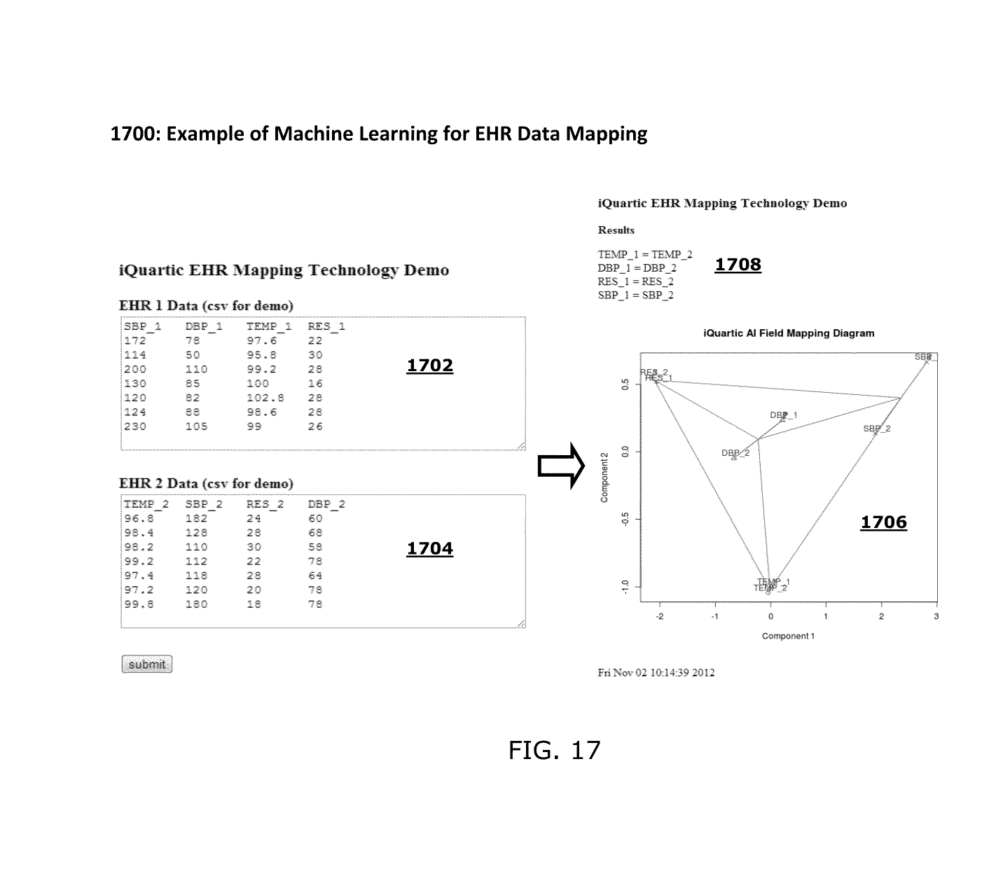

Processes and a system for adaptive EHR mapping based on machine learning are illustrated in FIG. 6, FIG. 7, FIG. 8, and FIG. 17. FIG. 6 reveals process 600 that applies machine learning to achieve semi-automated (and in some embodiments, automated) EHR data mapping. As described herein, the phrase, “Machine learning,” is used interchangeably with the phrases, “Artificial intelligence,” and “Data mining.” As described herein, the term, “Key,” is used interchangeably with the terms, “Field,” “Column,” “Variable,” “Attribute,” “Name,” and the phrase, “Data element”; each reflect a metadata representation for an atomic unit of data that has precise meaning and semantics. As described herein, the term “Value,” is used interchangeably with the phrase “Instance data,” representing data stored within or assigned to a key. For example, in a relational database field that contains blood pressure measurements, the key would be the blood pressure field while the values would be the specific blood pressure measurements stored within the blood pressure field. Keys may have associated attributes. For example, a field may have a name, data type, length, and other characteristics. Each of these characteristics is an attribute of the field.

Process 600 is intended to apply to a plurality of data sources, of which at least one may be an EHR data source or derived from an EHR data source. For example, process 600 may be used to semi-automatically (or in some embodiments, automatically) map an EHR data source to a reference standard schema (such as SNOMED), two or more EHR data sources to each other, (including from multiple EHR vendors each with unique metadata representations), an EHR data source with a claims data source, and EHR data source with an environmental and/or geographical data source, and EHR data source with a smartphone application data source, etc. Additionally, process 600 may apply to non-EHR data sources.

Process 600 begins with retrieving data from one or more sources 602. These sources may be external or internal to the system running process 600. Sources 602 may be retrieved with use of APIs, database connections, screen scrapers, ETL processes, import statements, and any other means to gather data. Optionally, gathered data may undergo transformation 604 and/or may be used to compute descriptors. Some examples of transformations that may be used in any combination or not at all include transpositions, joins, deriving new computed values, encoding, translations, attribute selection, splitting fields, summarizations, aggregations, sorting, subsetting, filtering, decompositions, data cleansing, text mining, standardization, applying a function, and normalization. Transformation may be applied at the schema level, the field level, and/or the value level. For example, a transformation may include computing the mean value or z-scores of a field. As another example, a transformation may include parsing and recoding a field name.

At least one machine learning algorithm 606 may be applied to either the 602 source data or the 604 transformed data to assess likely mappings between one or more source schemas and/or one or more source schemas and a reference schema (a target schema). The mappings may include schema matches and/or transformations to convert from one field to another, as is the case when, for example, one field includes temperature readings in Fahrenheit and another field includes temperature readings in Celsius. The mappings may reveal mapping cardinalities, including 1:n, n:1, and/or n:m matches between fields. Output from machine learning algorithm 606, which may include pairwise comparisons and/or comparisons between any combination of fields across all data sources or a subset thereof, may undergo transformation 608. For example, if machine learning algorithm 606 output includes probability of match between all combinations of fields, transformation 608 may include filtering to include only the combinations in which the probability of field match is above some threshold, then sorting the result to order the pairs by most likely to least likely to map.

Results derived from machine learning algorithm 606 and/or a transformation 608 thereof are used to make a determination 610 about which fields likely map to one another. Optionally, code 612 and/or one or more mapping tables may be generated to perform or enable an ETL process to perform mappings based upon determination 610. Optionally, a report 614 may be generated that reveals the confidence of each field mapping based on determination 610. This confidence may be presented as a probability of the fields mapping, shown as a percentage bounded between 0 and 100. Report 614 may be conveyed through a web-based graphical user interface, a printed document, an email, or any other means of communication. Optionally, a user interface 618 may enable review, manual adjustment, and/or overriding of any of the mappings. A data adapter 620 may be generated, either automatically or manually coded, that uses code 612 to apply the mappings to new source data entering the system. For example, if new values enter the system on a daily basis, data adapter 620 would automatically map the new data values. An updating process 622 would enable continuous, real-time assessment and processing of new fields and/or entirely new data sources as they enter the system.

Numerous embodiments of process 600 exist and have been implemented. Process 700 reveals a supervised learning algorithm embodiment to process 600. Process 700 begins with creating a reference schema 702 (a target) to which all source data should be mapped. Reference schema 702 may utilize an industry standard such as SNOMED, but could represent any arbitrary schema. In some embodiments, information gathered from one or more data sources may be used directly and/or to generate reference schema 702. Alternatively, reference schema 702 may be manually created by adjusting keys, attributes, values, and general structure of a data source, or may be constructed using an unstructured learning algorithm. Reference schema 702 may optionally undergo transformation 704 to a structure that is more appropriate for subsequent analysis steps. For example, transformation 704 may include conversion of the reference schema into key-value pairs. Transformation 704 may also include one or more text mining procedures, including but not limited to singular value decomposition, tokenization, stop word filtering, parts of speech analysis, term roll-up, term-frequency matrix computation(s), and other natural language processing techniques. Either reference schema 702 and/or the result from transformation 706 may undergo further empirical transformation 706, including but not limited to standardization of data and/or creation of descriptors based on one or more keys and/or values.

A supervised learning algorithm 708 is trained to output a key classification and/or values that may be used to enable field classification using input from reference schema 702, structural transformation 704, and/or empirical transformation 706. Supervised learning algorithm 708 is one embodiment of machine learning algorithm 606 and may include, but is not limited to one or more neural networks, decision trees, support vector machines, naive bayes classifiers, random forests, inductive logic, etc.

Using trained supervised learning algorithm 708, new source data may be scored 710 such that each value and/or field of the new data is assigned a key and/or a tag that enables assignments to a key that corresponds to reference schema 702. Prior to scoring, the new source data may be transformed in a similar fashion to the data used to construct supervised learning algorithm 708. In addition to a classification, supervised learning algorithm 708 may output additional scoring information and/or diagnostics, such as the certainty of the classification. Output from scoring 710 may optionally undergo standardization 712 or other transformation. Furthermore, scoring 710 output and/or output from standardization 712 may undergo aggregation 714. For example, if scoring 710 occurs at the value-level whereby each value within one or more keys is classified, aggregation 714 may include the system averaging the value-based scores for each key to determine the classification at the key-level. As another example, if a source field named “X” has 70% of its values scored as “Blood Pressure,” each score having an average confidence of 95%, this information may be aggregated to classify the entire field “X” as “Blood Pressure.” Additionally, computations may be performed to arrive at a confidence estimate for the key (field) classification based on assessing the scores of the value classifications.

Using output from scoring 710, standardization 712, and/or aggregation 714, a determination 716 of schema mapping may be made. Optionally, code 718 and/or one or more mapping tables may be generated to perform or enable an ETL process to perform mappings based upon determination 710. Optionally, at least one report 720 may be generated that reveals the confidence of each field mapping based on determination 716. This confidence may be presented as a probability of the fields mapping, shown as a percentage bounded between 0 and 100. Report 720 may be conveyed through a web-based graphical user interface, a printed document, an email, or any other means of communication. Optionally, a user interface 722 may enable review, manual adjustment, and/or overriding of any of the mappings. A data adapter 724 may be generated, either automatically and/or manually coded, that uses code 718 to apply the mappings to new source data entering the system. For example, if new values enter the system on a daily basis, data adapter 724 would automatically map the new data values. An updating process 726 may enable continuous, real-time assessment and processing of new fields and/or entirely new data sources as they enter the system.

Process 800 reveals an embodiment of process 600 that is based on unsupervised machine learning. One or more descriptors 802 are computed for one or more fields presented in one or more data sources and/or a reference. Descriptors 802 may be based on values in the fields and/or metadata related to one or more fields. An example of a descriptor is the mean value of a numeric field. The mean value is a descriptor (or attribute) of the field. Optionally, text mining 804 may be applied to generate descriptors, using methods that may include but are not limited to singular value decomposition, tokenization, stop word filtering, parts of speech analysis, term roll-up, term-frequency matrix computation(s), and other natural language processing techniques. Optionally, descriptors may undergo standardization 806. For example, standardization 806 may include computation of z-scores based on descriptors.

An unsupervised learning algorithm 808 is applied to assess “closeness” between fields originating from a plurality of sources based on analysis of descriptors 802, text mining 804, and/or standardization 806 output. The unsupervised learning algorithm 808 is an embodiment of machine learning algorithm 606 and may include, but not be limited to, cluster analysis and blind signal separation approaches. Algorithms that include, but are not limited to neural networks, support vector machines, self-organizing maps, and/or adaptive resonance theory may be used. While applying unsupervised learning algorithm 808, restrictions may be placed on said algorithm. For example, in cases where ten fields exist in each of two data sources and it is known that both sources contain the same semantic data, a restriction may include enforcing a clustering algorithm to output ten clusters, one for each unique semantic key. Restrictions may be constructed manually and/or automatically based on analysis of source and/or reference data. Optionally, transformation 812, including but not limited to estimating the probability of field-cluster membership and/or computing additional diagnostics may be performed.

Using output from unsupervised learning algorithm 808 and/or output from transformation 812, a determination 814 of schema mapping may be made. Optionally, code 816 and/or one or more mapping tables may be generated to perform or enable an ETL process to perform mappings based upon determination 814. Optionally, at least one report 818 may be generated that reveals the confidence of each field mapping based on determination 814. This confidence may be presented as a probability of the fields mapping, shown as a percentage bounded between 0 and 100. Report 818 may be conveyed through a web-based graphical user interface, a printed document, an email, or any other means of communication. Optionally, a user interface 820 may enable review, manual adjustment, and/or overriding of the mappings. A data adapter 822 may be generated, either automatically or manually, that uses code 816 to apply the mappings to new source data entering the system. For example, if new values enter the system on a daily basis, data adapter 822 would automatically map the new data values. An updating process 824 would enable continuous, real-time assessment and processing of new fields and/or entirely new data sources as they enter the system.

FIG. 17 is an example screenshot demonstrating input and output from an implementation of process 600 and process 800. Data from a plurality of heterogeneous data sources, represented by EHR 1 (1702) and EHR 2 (1704), are shown. As made clear by inspecting EHR 1702 and EHR 1704, it would be difficult to map data between the two systems using conventional systems integration methods since the schemas are different; neither of the two sources have any fields in common based on inspection of the field names. In such cases, it is common practice to manually rename fields, create staging areas, and otherwise manually attempt to map the data. However, such industry methods do not scale well. Given the over 600 EHR vendors currently operating in the market and a lack of industry-wide EHR schema standards, process 600 represents the first scalable solution to this EHR integration challenge. After running process 800, 1708 reveals an outputted determination of field mappings and 1706 reveals a diagnostic plot showing the “closeness” of fields between the two systems. Example 1700 is presented via a report 818 and web user interface 820.

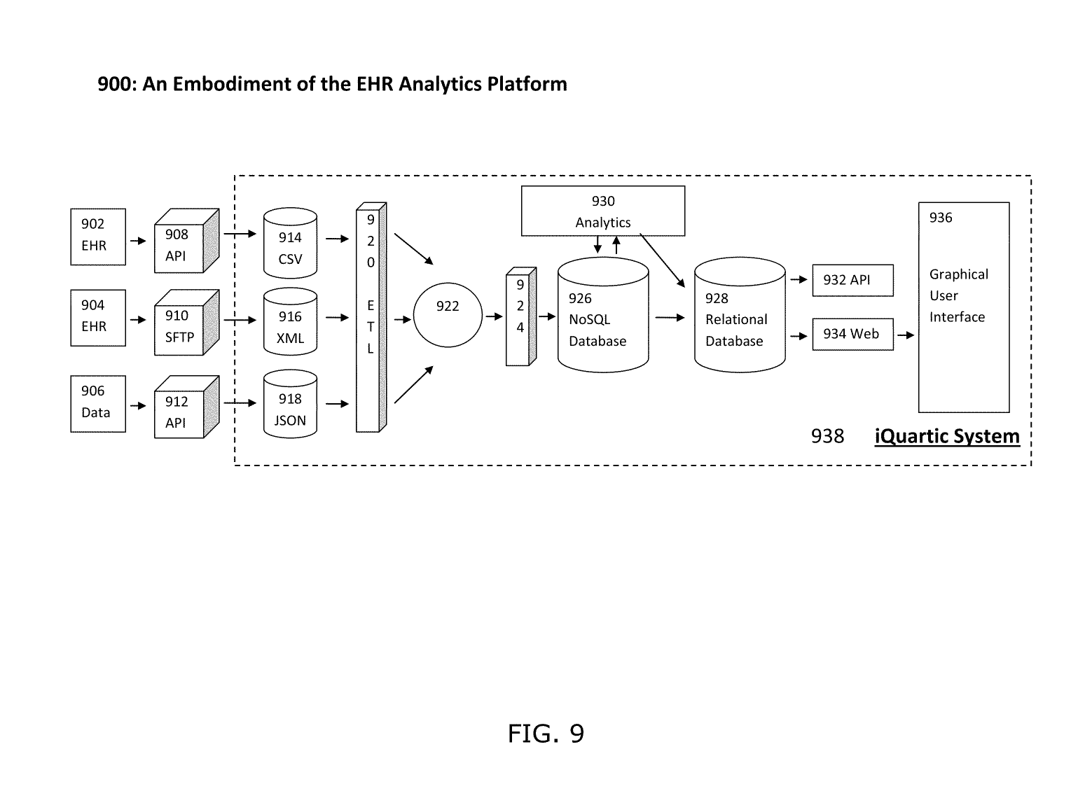

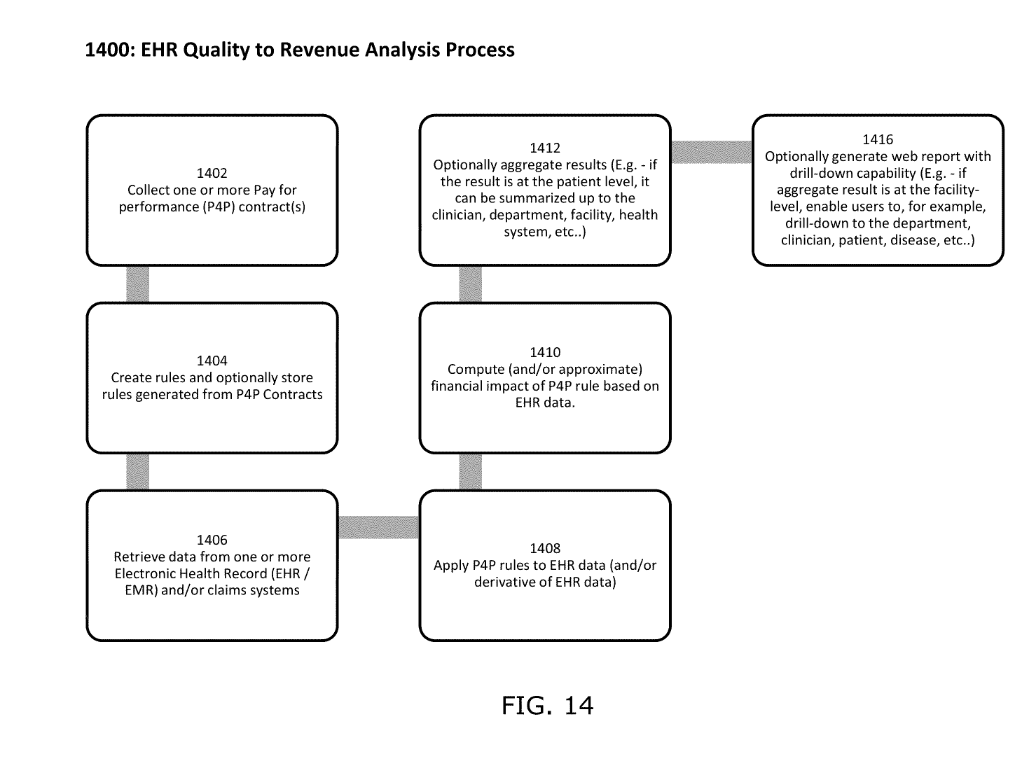

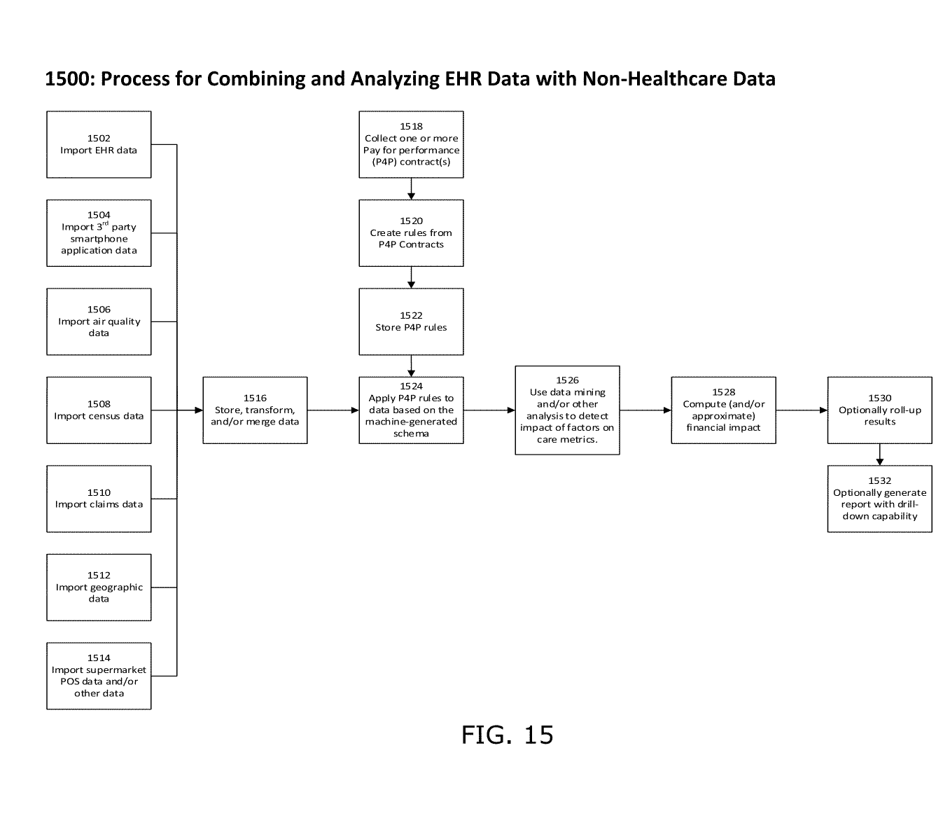

FIG. 9 reveals one embodiment of the system 100 described herein. Data is gathered from one or more data sources, represented by EHR 902, EHR 904, and Data 906. Data may be retrieved from a variety of sources, not just EHR technologies. For example, as shown in FIG. 15, other data sources that may be used include, but are not limited to, smartphone application data 1504, air quality data 1506, census data 1508, claims data 1510, geographic data 1512, and/or supermarket POS data 1514. Data sources 902-906 may be gathered with the assistance of an application programming interface 908, an email, FTP, SFTP 910, HTTP, or any other means to transmit and/or access data. Upon entering the system 938, the data may be archived in its native format, as shown by the storage of data to CSV 914, XML 916, and JSON 918. An ETL process 920 may be used to transform data from its native format into a canonical representation 922. Canonical representation 922 may undergo an ETL process 924 to load it into a database, represented by NoSQL database 926. Analytics 930 may be performed on data stored in database 926, including but not limited to machine learning, statistics, and other computations. Analytics 930 may be used by any number of modules and for any number of tasks, including but not limited to computing the impact of delivery quality on revenue as shown in FIG. 14, geospatial analysis as shown in FIG. 13, EHR data quality audits, predicting emergency room readmissions, predicting risk, predicting revenue, predicting quality, and computing any descriptive and/or inferential measure that may be meaningful to users of system 938. Additionally, analytics 930 may be used to enable gamification of healthcare quality improvement, whereby clinicians or other entities are continuously evaluated by system 938 and presented with how they stand and have changed across various key performance indicators over time. Analytics 930 may be synchronously and/or asynchronously ran in relation to requests from the user interface 936 and/or requests from API 932. Furthermore, analytics 930 may automatically be run on a schedule or in response to changes in one or more databases and/or a request from the graphical user interface 936 and/or API 932.

Graphical user interface 936 may be supported by web API 934, creating a layer of separation between user interface 936 and database 928 for enhanced security and functionality. For example, web API 934 may enable queuing of requests made by user interface 936 and control user permissions. A user does not need to necessarily access system 938 via the graphical user interface 936. Rather, a user and/or another computer application may interact with system 938 via API 932.

Relational database 928 may be used to store results from analytics 930, representations of data stored in database 926 and/or subsets of data from database 926. In some embodiments, database 926 and 928 may be combined into a signal database system. In the preferred embodiment, NoSQL database 926 is implemented to enable rapid analysis of data at large scale that would not be feasible using current relational database technologies. Relational database 928 is implemented to support querying processes that are typical for web reporting, but not yet supported by current NoSQL technologies.

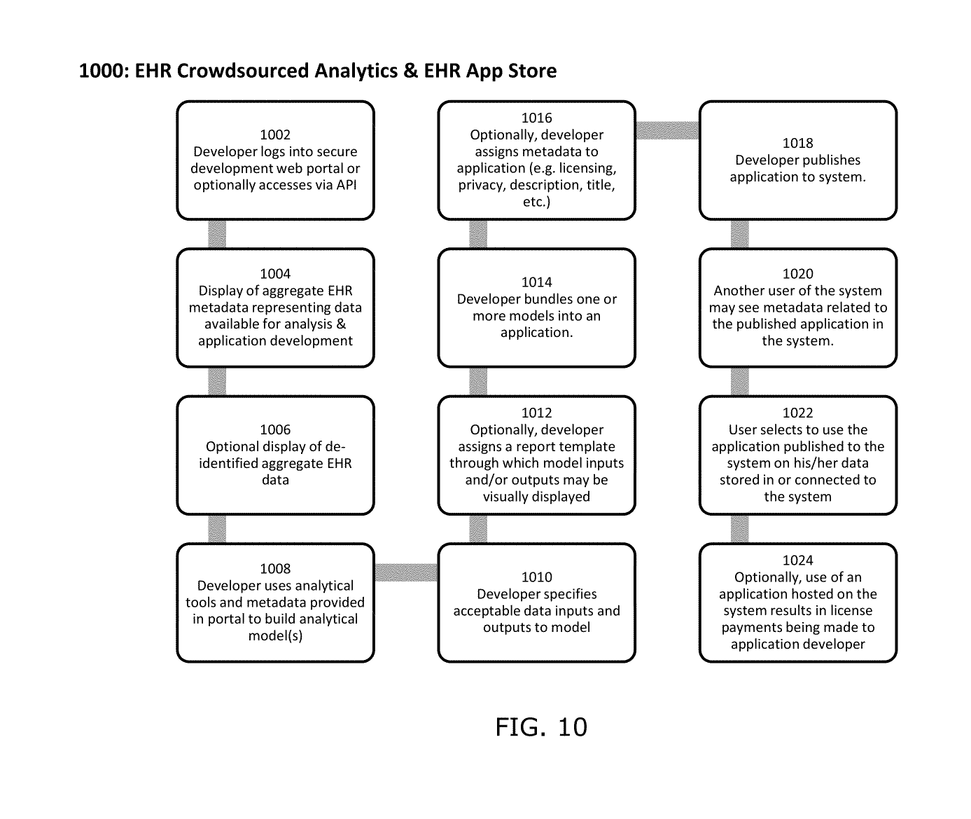

As illustrated in FIG. 10, process 1000 relates to EHR crowdsourced analytics and an EHR application store. Developer 1002 logs into a secure development web portal or optionally accesses portal via interface 114. Process 1000 may display 1004 metadata representing data available for analysis and application development; in the preferred embodiment, this data would include data from a plurality of EHR sources. Process 1000 may also optionally display 1006 non-sensitive data as disclosed herein. Process 1000 may include a step where a developer specifies 1010 acceptable data inputs and outputs that are to be used as part of the analysis. Process 1000 may include, optionally, a step where developer 1012 assigns a report template through which model inputs and/or outputs may be visually displayed. Process 1000 may include a step where developer bundles 1014 one or more models into an application. Process 1000 may include a step where, optionally, developer assigns 1016 metadata to the application, such as licensing, privacy, description, title, and the like. Process 1000 may include a step where a developer publishes 1018 the application to the web-based EHR application store, supported by application module 130. Process 1000 may include a step where another user sees 1020 or otherwise is presented information related to the published application in the EHR application store. Process 1000 may include a step where a user selects 1022 to use the application published to the EHR application store on their data store in the system 100. Process 1000 may include a step where an application is hosted 1024 on the platform or system 100 and that results in license payments being made to the application developer.

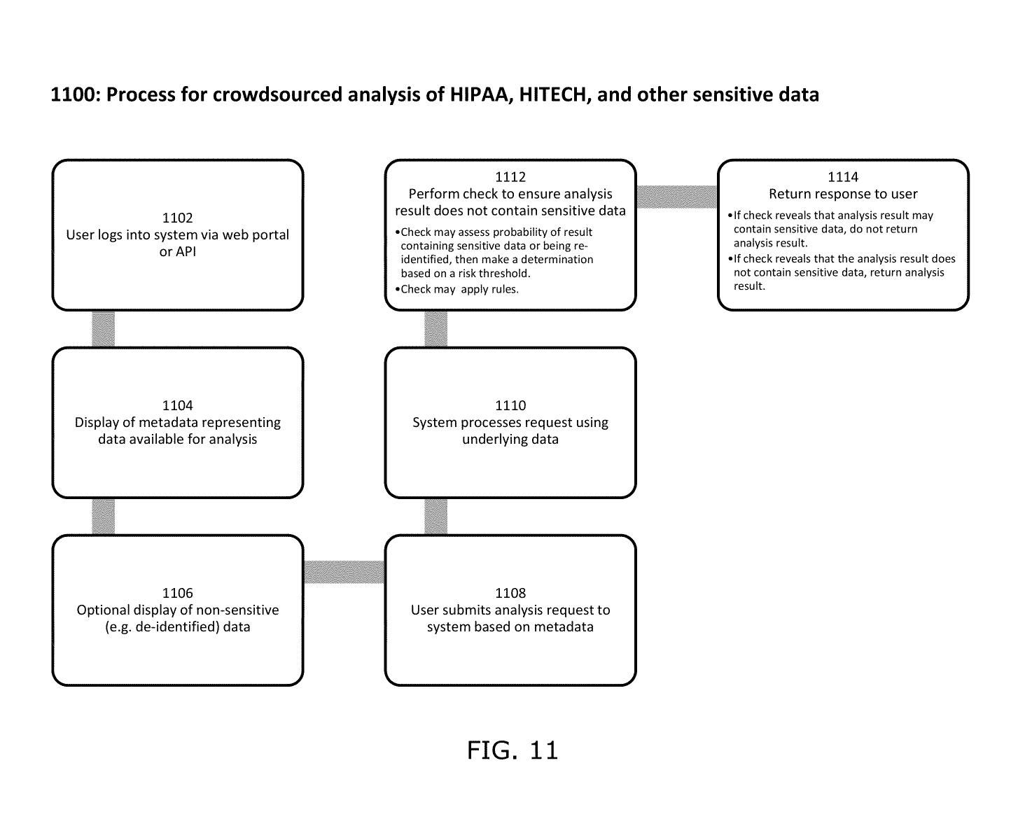

FIG. 11 reveals a process for crowdsourced analysis of HIPAA, HITECH, and other sensitive data, including but not limited to Personally Identifiable Information (PII). Process 1100 may be implemented to securely enable the EHR crowdsourced analytics and EHR app store process as shown in FIG. 10.

Clinical data mining and pattern detection, specifically the ability to predict risk and identify opportunities for improved patient care and efficiency, have long been advertised as potential benefits of EHR. However, the ability to democratize such research and enable large scale, near real-time data access to cross-disciplinary investigators has been hampered by data access and security challenges. While other industries such as meteorology have observed magnitudes of efficiency improvements as a consequence of providing near real-time data access to investigators, the healthcare industry has been left behind due to lack of openness, much rooted in legitimate patient privacy concerns.

Kaggle, a web technology that hosts data mining competitions where teams compete for prizes to solve predictive modeling challenges, has recently been used as a forum for public crowdsourcing of analysis. The “Heritage Health Prize,” currently the largest hosted competition, aims to predict hospital admissions over the upcoming year using historic claims data. While participants to this and similar crowdsourced healthcare competitions have varied industry backgrounds and expertise, including representation from the health and life sciences, the winning teams to the healthcare competitions rarely have healthcare backgrounds. For example, “Market Makers,” the winning team to Round 1 of the Heritage Health Prize, is comprised of three team members, two of which are financial managers. The current Round 2 leading team is led by a professional hacker and an econometrician. In a similarly crowdsourced competition to predict HIV progression given limited clinical information, the winner, Chris Raimondi, is a search engine optimizer and internet marketer. In a competition to identify patients with a diabetes diagnosis using limited clinical data, the winning team to date is led by Sergey Yurgenson, a physicist. These early observations reinforce that the proposed framework be designed to enable participation by users beyond the health and life science space.

Public access to clinical data like that contained in EHRs has the potential to be used to discriminate and cause harm to individuals represented by the data. For this reason, the Health Insurance Portability and Accountability Act of 1996 (“HIPAA”) enacted Privacy and Security rules to protect patient information and impose strict penalties for noncompliance. While HIPAA has clearly protected patient confidentiality, the Privacy rule, in particular, has increased the cost and reduced the quality of medical research by making it more difficult to exchange health-related information.

The components of data protected by HIPAA Privacy and Security rules are limited to individually identifiable health information, known as Protected Health Information (PHI). Herein, the term, “PHI” is used interchangeably with the term, “PII,” which stands for “Personally Identifiable Information.” HIPAA does not protect nor restrict the use of de-identified health information, which is explicitly excluded from PHI. Covered entities may use or disclose health information that is de-identified without restriction under the Privacy Rule. Therefore, it is possible, through system 100, to enable provisioning of near real-time, metadata and de-identified clinical data to the public. Furthermore, system 100 may be used to perform statistical and other analysis of patient-level clinical data that includes PHI without the researcher having the ability to directly view PHI data.

The ability for researchers across the globe to perform large-scale, near real-time analysis and data mining of integrated EHR records from disparate systems while fully adhering to HIPAA regulations is a breakthrough that may vastly increase patient privacy and better protect patient confidentiality. Currently, protected patient data passes through many hands, with ad-hoc access decisions being made by Institutional Review Boards (“IRBs”) on a case-by-case basis. While this environment provides some measure of patient protection, it would be difficult to determine just how many researchers world-wide have protected patient information in their possession. The ability for researchers to perform analysis of clinical data without having access to the data would enable reduction, if not elimination, of individual researcher possession of protected information.

The process shown in FIG. 11 may have the following direct impact on clinical, outcomes and public health research, all yielding improvements in patient care and healthcare efficiency, especially in underserved populations:
1. Increase the pace of research and findings, creating new lines of research
2. Improve research quality via competition; more entrants
3. Increased collaboration between geographically-dispersed researchers
4. Democratization of the research process
5. Rapid validation and peer-review of findings
6. Reduced costs to research institutions
7. Creates a mechanism for research findings to more rapidly be deployed at the patient bedside.

Currently, the process for researchers to gain timely access to clinical data such as that stored across EHRs is costly, difficult, and inefficient. Often, researchers are required to go through layers of approval processes with IRBs before gaining access to raw data that may not even be suitable for the designated research purposes. These challenges have the effect of delaying research that may ultimately save lives and lower costs. The invention herein offers an approach to overcoming this access barrier while providing better patient privacy protections over the status quo, thereby hastening the pace of clinical, outcomes, and public health research.

Researchers often require complete, longitudinal clinical data to support their investigatory efforts. While several EHR vendors have attempted to make de-identified patient records more easily accessible, it is rare for all patient information to be stored in a single EHR system. Patients often seek care from different clinical practitioners who work in varied facilities, each facility using a different EHR system. Conversely, there exist facilities that utilize numerous EHR systems in parallel. The process described herein enables large-scale analysis in these settings.

The ability for international researchers to rapidly analyze patient-level data in near real-time is expected to increase the number of investigators and the frequency of their investigations while pushing down, if not eliminating, costs associated with ad-hoc research requests for data. Furthermore, the quality of the research is also expected to increase as a consequence of both increased competition and increased collaboration. For example, in the wake of Google making its Google Maps data more readily accessible to the public, myriads of applications and technologies, from GPSs to smartphones, were developed around the technology to improve our ability to navigate. Similarly, after Apple began providing developer access to its iPhone, the world of mobile phone “apps” was born, creating an entirely new industry resulting from the crowdsourcing of expertise. System 100 provides a means to enable a crowdsourced application environment (“apps”) for EHR data, where researchers from all industries may input and share expertise related to their analysis of data accessible via the invention. These apps would run in near real-time via application module 130, providing insights across a spectrum of health-related challenges.

First, a user executes a login 1102 to the system. After login 1102, metadata 1104 representative of data available for analysis may be displayed to the user. Data available for analysis may be derived from one or more sources, including but not limited to an EHR, claims, geospatial, census, and any other source. Optionally, the ability for the user to view non-sensitive data 1106 may be permitted. Data and/or metadata available to the user may vary by user based on the user's permissions with system 100. The user may submit an analysis request 1108 to the system. Analysis request 1108 may use references to metadata elements as part of its content. Analysis request 1108 may include, but is not limited to, computer instructions to perform a data query, apply a function, perform descriptive or inferential analysis, and/or run data mining algorithms.

The system will process 1110 request 1108, and may perform computations on the data stored in and/or connected to system 100. The system performs a check 1112 on the analysis request and/or the results of the analysis request to ensure the result will not contain sensitive data. Check 1112 may assess the probability of the result containing sensitive data and/or being re-identified in the case of PII, then make a determination based on a risk threshold. Alternatively and/or in combination, check 1112 may apply rules in its determination of whether or not the analysis result may contain sensitive data. The system will then return a response 1114 to the user based on the results of check 1112. If check 1112 reveals that the analysis result may contain sensitive data, the result of the analysis will not be returned to the user. If check 1112 reveals that the analysis does not contain sensitive data, analysis results may be returned to the user. In the event that the check does not pass, the system may return a subset of the response that does not include the sensitive data. From the time analysis request 1108 is submitted to the time of response 1114, the system may notify the user that request 1108 is being processed; this notification may be rendered via a web-based graphical user interface, and email, or any other means of communication with the user.

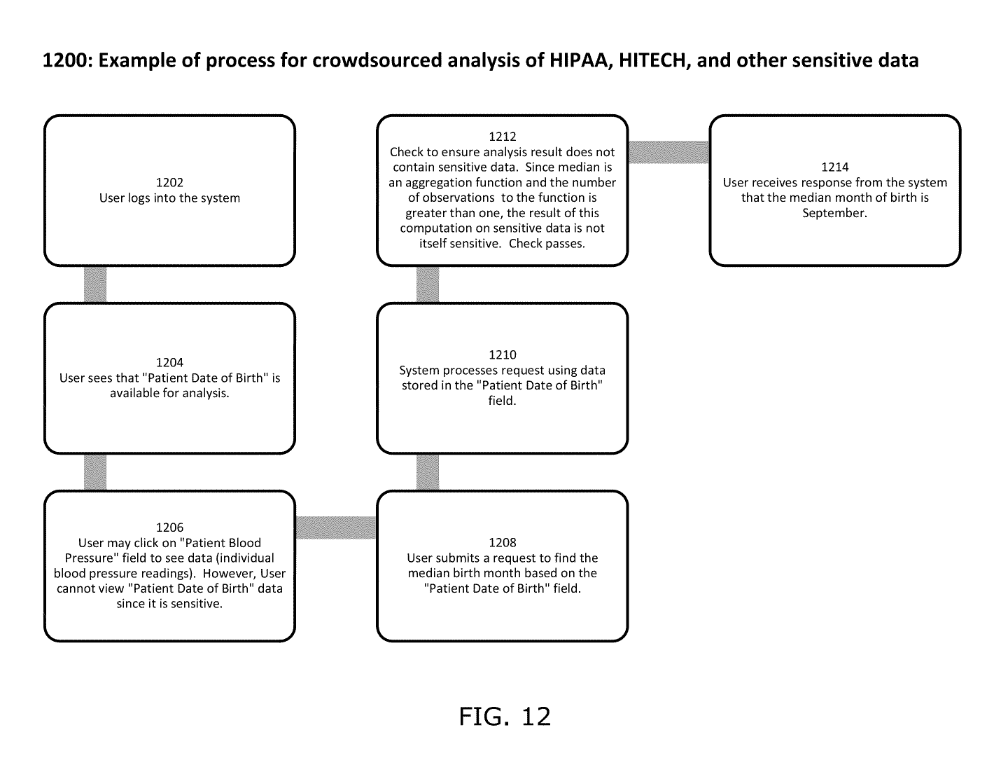

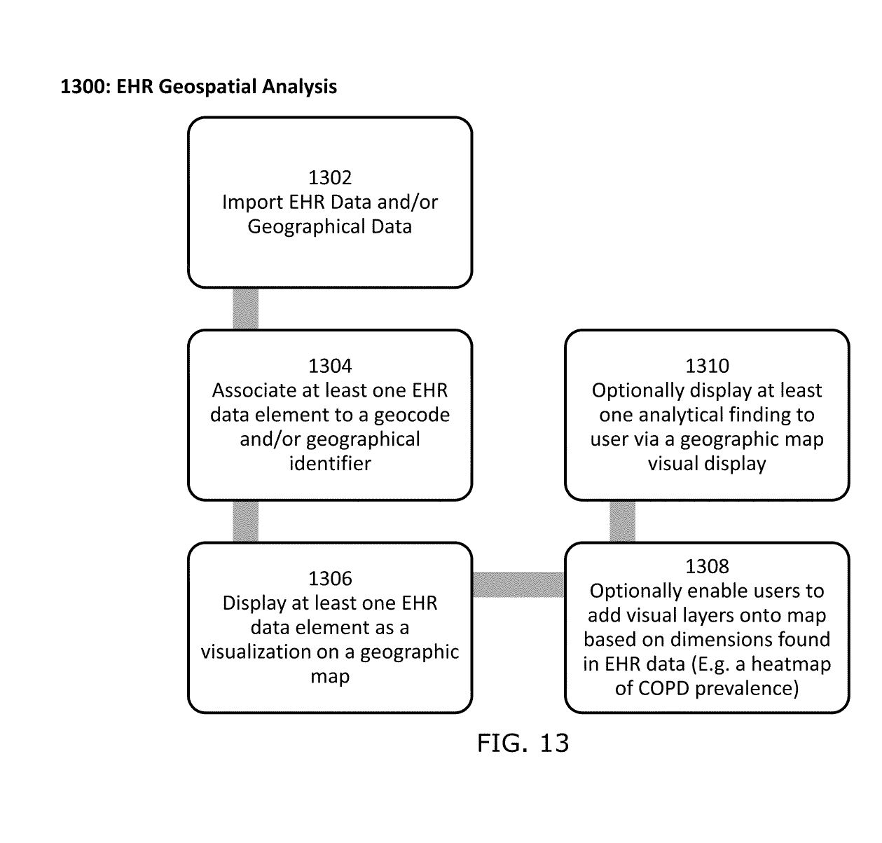

FIG. 12 reveals an example of the process shown in FIG. 11. A user performs a login 1202 to the system. The user is shown that data element 1204 “Patient Date of Birth,” is available for analysis. However, the user may not have access to the underlying data 1206 for the “Patient Date of Birth” field since date of birth is sensitive data (PII). The user may be able to view and/or otherwise access non-sensitive data, such as the data contained in the “Patient Blood Pressure” field. The user submits an analysis request 1208 to the system that asks it to compute the median birth month across data within the sensitive “Patient Date of Birth” field. The system processes 1210 the request to assess the median birth month of “Patient Date of Birth.” Check 1212 is performed to determine if the results of process 1210 may contain sensitive information. In this case, since median is an aggregation function and the number of observations in the “Patient Date of Birth” field that are used in the analysis is greater than 1, the check 1212 may pass. The system returns a response 1214 to the user that reveals the median month of birth is September.

FIG. 13 reveals a process for geospatial analysis of EHR data. Data 1302 is gathered from one or more sources, including at least one EHR and/or clinical source. At least one data element in data 1302 is associated with a geocode and/or a geographical identifier. For example, patient blood pressures may be associated with geocodes based upon the last known residence and/or work address of the patient. Visual display 1306 of EHR data as layers, symbols, colors, and/or other indicators on a geographical is enabled. Optionally, users may interact 1308 with the associated 1304 data; this interaction may be enabled through a web-based graphical user interface, an API, and/or any other means of communication with a user. Optionally, the system may display at least one analytical finding 1310 as a result of the association 1304 of EHR data with geographic data. For example, layering patient blood pressure on a map may reveal geographical “hot spots” —clusters of patients in a region—that have high blood pressure. By additionally layering food sources, visual display 1306, interaction 1308, and/or analysis 1310 may reveal that hot spots of high blood pressure are correlated with food deserts (e.g. a lack of grocery stores selling nutritious foods) in the region. As another example, overlaying EHR data on geographical maps may reveal that patients who commute long distances, are in high-traffic areas, and/or are in regions with high crime display different health patterns than those patients in other areas.

FIG. 14 reveals a process to assess the financial impact of healthcare quality on a variety of users. One or more payment contracts 1402 that include but are not limited to pay for performance (P4P), pay for outcomes (P4O), value-based payment, fee for service, non-“fee for service”, and/or at-risk payment contracts, are gathered. The contracts 1402 are then analyzed, automatically by machine and/or manually, to create a set of rules 1404 that may be optionally stored. Rules 1404 contain information related to how payments are assessed in relation to quality measures. Data 1406 is gathered from one or more systems that may include, but not be limited to, EHRs and claims databases. Data may be transformed as previously described herein, especially in process 600, 700, and 800. Rules 1404 are then applied 1408 to data 1406 and/or a representation thereof, followed by computation 1410 of the financial impact of rules in light of data 1406. Results may be aggregated 1412.

FIG. 15 illustrates a process 1500 for combining and analyzing EHR data with non-healthcare data. The process 1500 may include gathering data from a variety of sources and a variety of steps. For example, the process may import 1502 EHR data. The process may import 1504 third party smartphone application data. The process may import 1506 air quality data. The process may import 1508 census data. The process may import 1510 claims data. The process may import 1512 geographic data. The process may import 1514 supermarket point of sale data and/or other data. The process may utilize one or more of these data sources and then store 1516, transform, and/or merge the data within a database or the like provided in system 100 and data source 160. Additionally, process 1500 may collect 1518 one or more pay for performance (P4P) contracts. The process may create 1520 rules for P4P contracts. The process may store 1522 P4P rules. The process may apply 1524 P4P rules to data based on the machine-generated schema. This step 1524 may be subsequent to step 1516. The process may use data mining 1526 and/or other analysis to detect impact of factors on care metrics. The process may compute 1528 (or alternatively approximate) the financial impact of the defect impact determined in step 1526. The process may roll-up 1530 the results of the financial impact determined in step 1528. The process may generate 1532 a report with drill-down capability in order to improve efficiency.

FIGS. 16A through 16D illustrate various reports provided by system 100 and the one or more processes and methods described herein. FIG. 16A illustrates a cost of non-compliance for a system as a whole In this manner, a manager or financial officer can quantify the revenue lost due to non-compliance and then may be able to determine if corrective measures are justified. As illustrated in FIG. 16B, a report may be generated that identifies the areas where non-compliance has and/or is likely to cost the healthcare service organization the most losses. FIG. 16C illustrates a compliance rate of individual care providers, such as clinicians, and an itemized list of provider compliance rates and their estimated financial impact on the organization. FIG. 16D illustrates a compliance rate of patients and an itemized list of patient compliance rates and their estimated financial impact on the organization.

One or more methods may be disclosed herein. For example, one method may include receiving healthcare-related information including financial, patient, and provider related information from at least one electronic source, and determining a performance indicator of the healthcare-related information. At least one electronic source may be EHR systems 162 of data source 160. The performance indicator may be, for example, an indicator of projected revenue losses such as those illustrated in the graphs of FIG. 16A.

The method may include identifying one or more corrective measures based on the performance indicator. A corrective measure may be to determine the reason for non-compliance and addressing that reason with further training, automated processes, or any other effective and appropriate corrective measure.

Receiving healthcare-related information may include receiving information related to quality of care guidelines of a pay for performance healthcare provider contract. Determining a performance indicator may include determining, based on the quality of care guidelines, a compliance rate of a pay for performance contract for a given service provider.

Receiving healthcare-related information may include receiving information related to quality of care guidelines. Determining a performance indicator may include determining, based upon the quality of care guidelines, a compliance rate for a given ailment.

Identifying one or more corrective measures may include communicating the one or more corrective measures to a service provider via electronic message. The electronic message may be an email to a provider, or, alternatively, may be a text or SMS based message for instant notification.

Receiving healthcare-related information may include receiving information related to quality of care guidelines. The one or more methods may include determining that one or more of the quality of care guidelines has not been satisfied. The one or more methods may include determining a financial loss associated with the one or more of the quality of care guidelines that has not been satisfied.

Determining a financial loss may include determining a financial loss and/or predicted financial loss for a given service provider in a healthcare organization. The one or more methods may also include assigning a rank to the financial loss for a given service provider in the healthcare organization.

Identifying one or more corrective measures may include communicating the rank and/or a performance score to the service provider.

Determining a financial loss may include determining a financial loss and/or predicted financial loss for a given department in a healthcare organization. The one or more methods may also include assigning a rank of the financial loss for a given department in the healthcare organization.

Receiving healthcare-related information may include receiving information related to quality of care guidelines. The one or more methods may include determining a performance indicator that includes determining if quality of care guidelines is satisfied for each patient.

Identifying one or more corrective measures may include identifying a patient to which quality of care guidelines have not been satisfied, and the one or more methods may further include communicating to the service provider instructions to satisfy the quality of care guidelines for the patient.

Receiving healthcare-related information may include receiving information related to patient treatment history and medical condition. Determining a performance indicator may include determining, based off the information related to patient treatment history and medical condition, patients that are high-risk. Identifying corrective measures may include sending recommendations to the high-risk patent.

Receiving healthcare-related information may include receiving geographical information related to one of the residence of a patient or the location of a healthcare provider. Determining a performance indicator may include determining a spatial relationship of rendered medical services to a geographic region based on the geographical information related to one of the residence of a patient or the location of the healthcare provider.

The one or more methods may include displaying, on a user interface, data indicative of the spatial relationship.

Receiving healthcare-related information may include receiving healthcare-related information on a computing device.

Receiving healthcare-related information may include receiving financial information of one of a patient, service provider, department, and location. Determining a performance indicator may include determining spending data based on the financial information. The one or more methods may include comparing the spending data of each of the one of the patient, service provider, department, and location.

Receiving healthcare-related information may include receiving healthcare-related information from a plurality of electronic health record providers. The one or more methods may include calculating an empirical similarity between disparate entries of the plurality of electronic health record providers and determining, based on the empirical similarity, whether disparate entries are indicative of the same information from the plurality of electronic health record providers.

Healthcare-related data may include at least one of electronic health records and environmental records. In this manner, any data that may be useful in making an assessment of health or other health related determination may be used.

Environmental records may include one of geography, temperature, air quality, and combinations thereof.

The method may include receiving non healthcare-related records. Ton healthcare-related records may include one of income distribution, and government provided labor and economic data, and combinations thereof.

The one or more methods may include communicating the performance indicator to a requestor.

The one or more methods may include determining if a requestor has permission to receive the performance indicator.

The one or more methods may include displaying, on a user interface, a timeline that contains healthcare-related information for a given patient.

The one or more methods may include comparing metadata from the healthcare-related information in order to determine a performance indicator of the healthcare-related information.

The one or more methods may include determining if any of the healthcare-related information is sensitive information, and in response to determining that information is sensitive, obfuscating said information.

The one or more methods may include receiving programming instructions from a third party.

The one or more methods may include receiving healthcare-related information including financial, patient, and provider related information from a plurality of electronic sources, and comparing values from one of the plurality of electronic sources to values of another of the plurality of electronic sources to determine a likelihood of matching for a given pair of values.

The one or more methods may include comparing values from one of the plurality of electronic sources that may include comparing at least two values from one of the plurality of electronic sources to at least two values from another of the plurality of electronic sources.

The one or more methods may include plotting a frequency histogram for a given value of one of the plurality of electronic sources and plotting a frequency histogram for a given value of another of the plurality of electronic sources.

The one or more methods may include comparing values comprises comparing the frequency histogram for a given value of one of the plurality of electronic sources with a histogram for a given value of another of the plurality of electronic sources.

The one or more methods may include comparing values from one of the plurality of electronic sources comprises using a stochastic analysis.

The one or more methods may include comparing values from one of the plurality of electronic sources using a machine learning algorithm.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural, functional, or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
receiving healthcare-related information including financial, patient, and provider related information from at least one electronic source; and
determining, on a computing device, a performance indicator of the healthcare-related information.

2. The method of claim 1, further including identifying one or more corrective measures based on the performance indicator.

3. The method of claim 1, wherein:
receiving healthcare-related information comprises receiving information related to quality of care guidelines of a pay for performance healthcare provider contract; and
determining a performance indicator comprises determining, based on the quality of care guidelines, a compliance rate of a pay for performance contract for a given service provider.

4. The method of claim 1, wherein:
receiving healthcare-related information comprises receiving information related to quality of care guidelines; and
determining a performance indicator comprises determining, based upon the quality of care guidelines, a compliance rate for a given ailment.

5. The method of claim 2, wherein identifying one or more corrective measures comprises communicating the one or more corrective measures to a service provider via electronic message.

6. The method of claim 4, wherein receiving healthcare-related information comprises receiving information related to quality of care guidelines, and further comprising:
determining that one or more of the quality of care guidelines has not been satisfied; and
determining a financial loss associated with the one or more of the quality of care guidelines that has not been satisfied.

7. The method of claim 4, wherein determining a financial loss comprises determining a financial loss for a given service provider in a healthcare organization, and further comprising assigning a rank of the financial loss for a given service provider in the healthcare organization.

8. The method of claim 2, wherein identifying one or more corrective measures comprises communicating the rank to the service provider.

9. The method of claim 4, wherein determining a financial loss comprises determining a financial loss for a given department in a healthcare organization, and further comprising assigning a rank of the financial loss for a given department in the healthcare organization.

10. The method of claim 1, wherein:
receiving healthcare-related information comprises receiving information related to quality of care guidelines; and
determining a performance indicator comprises determining if quality of care guidelines are satisfied for each patient.

11. The method of claim 2, wherein identifying one or more corrective measures comprises identifying a patient to which quality of care guidelines have not been satisfied, and
further comprising communicating to the service provider instructions to satisfy the quality of care guidelines for the patient.

12. The method of claim 2, wherein:
receiving healthcare-related information comprises receiving information related to patient treatment history and medical condition;
determining a performance indicator comprises determining, based off the information related to patient treatment history and medical condition, patients that are high-risk; and
identifying corrective measures comprises sending recommendations to the high-risk patent.

13. The method of claim 1, wherein:
receiving healthcare-related information comprises receiving geographical information related to one of the residence of a patient or the location of a healthcare provider; and
determining a performance indicator comprises determining a spatial relationship of rendered medical services to a geographic region based on the geographical information related to one of the residence of a patient or the location of the healthcare provider.

14. The method of claim 12, further comprising displaying, on a user interface, data indicative of the spatial relationship.

14. The method of claim 1, wherein receiving healthcare-related information comprises receiving healthcare-related information on a computing device.

16. The method of claim 1, wherein:
receiving healthcare-related information comprises receiving financial information of one of a patient, service provider, department, and location; and
determining a performance indicator comprises determining spending data based on the financial information, and
the method further comprising comparing the spending data of each of the one of the patient, service provider, department, and location.

17. The method of claim 1, wherein receiving healthcare-related information comprises receiving healthcare-related information from a plurality of electronic health record providers, the method further comprising:
calculating an empirical similarity between disparate entries of the plurality of electronic health record providers; and
determining, based on the empirical similarity, whether disparate entries are indicative of the same information from the plurality of electronic health record providers.

18. The method of claim 1, wherein healthcare-related data comprises at least one of electronic health records and environmental records.

19. The method of claim 18, wherein environmental records comprises one of geography, temperature, air quality, and combinations thereof.

20. The method of claim 18, further including receiving non healthcare-related records, wherein non healthcare-related records comprises one of income distribution, and government provided labor and economic data, and combinations thereof.

21. The method of claim 1, further including communicating the performance indicator to a requestor.

22. The method of claim 21, further including determining if a requestor has permission to receive the performance indicator.

23. The method of claim 1, further including displaying, on a user interface, a timeline that contains healthcare-related information for a given patient.

24. The method of claim 1, further including comparing metadata from the healthcare-related information in order to determine a performance indicator of the healthcare-related information.

25. The method of claim 1, further including determining if any of the healthcare-related information is sensitive information, and
in response to determining that information is sensitive, obfuscate said information.

26. The method of claim 25, further including presenting obfuscated healthcare information to a public user.

27. The method of claim 25, receiving programming instructions from a third party.

28. A method comprising:
receiving healthcare-related information including financial, patient, and provider related information from a plurality of electronic sources; and
comparing values from one of the plurality of electronic sources to values of another of the plurality of electronic sources to determine a likelihood of matching for a given pair of values.

29. The method of claim 28, wherein comparing values from one of the plurality of electronic sources comprises comparing at least two values from one of the plurality of electronic sources to at least two values from another of the plurality of electronic sources.

30. The method of claim 28, further comprising plotting a frequency histogram for a given value of one of the plurality of electronic sources and plotting a frequency histogram for a given value of another of the plurality of electronic sources.

31. The method of claim 30, wherein comparing values comprises comparing the frequency histogram for a given value of one of the plurality of electronic sources with a histogram for a given value of another of the plurality of electronic sources.

32. The method of claim 28, wherein comparing values from one of the plurality of electronic sources comprises using a stochastic analysis.

33. The method of claim 28, wherein the method is carried out on computer programmable code embodied as an application on a mobile computing device.

34. A system comprising:
a data source having a plurality of electronic sources comprising one of electronic health record, non-clinical data, environmental data, and combinations thereof; and
an analytics module configured to:
receive data from a plurality of electronic sources of the data source; and
compare values from one of the plurality of electronic sources to values of another of the plurality of electronic sources to determine a likelihood of matching for a given pair of values.

35. The system of claim 34, wherein the system includes an application module, the application module having at least one application that is downloadable by a user.
